(19) United States
(12) Patent Application Publication
(10) Pub. No.: US 2005/0250073 A1
(43) Pub. Date: Nov. 10, 2005

(54) Reversible screw blockage, with application to the attachment of prosthetic abutments to dental implants

(76) Inventors: Yuval Arie Tresser, New York, NY (US); Michael Aflalo, Nice (FR); Ygael Aaron Tresser, Brooklyn, NY (US)

Correspondence Address: INVENTION S SOLUTION;C/O YUUD TRESSER, 478 CENTRAL PARK WEST, APT 3A, NEW YORK, NY, 10025, US

(21) Appl. No.: 10/837,582

(22) Filed: May 4, 2004

(51) Int. Cl. A61C 8/00

(52) U.S. Cl. 433/173

(57) ABSTRACT

We describe systems and methods that allow absolute security of the stability of screwing by screws when access to said screw is possible neither from the side nor from beneath. Said stability is achieved in a reversible way in the sense that unscrewing can easily be performed without breaking when needed. A variety of systems and methods are disclosed with these attribute, which can in particular apply to the trans-screwing of a prosthetic abutment on the crestal end of a dental implant, with many more applications.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Thanks to recent development at the level of prosthesis, modem oral implantology allows to perform unitary or plural rehabilitations in conditions that are now deemed satisfactory, and are both reproducible and predictable at the functional as well as at the cosmetic level.

When it comes to implant-based rehabilitations where implant emergences coincide with emergence of ex-natural abutments, a consensus has essentially been reached on the necessity of using esthetic systems called “screwed-and-sealed” in implant-based rehabilitations where the implant emergences coincide with the emergences of the natural ex-abutments.

By “screwed-and-sealed” one means a combination of two operations:
1): Trans-screwing—or trans-fixation—of the prosthetic abutment, i.e., attachment of said prosthetic abutment to the implant that serves as a support for trans-screwing or trans-fixing. This is achieved thanks to a screw that first goes through a pierced part of the prosthetic abutment and then gets screwed into the threaded chamber of the implant. This screw is usually called the trans-screwing screw or trans-fixation screw. Some screwing performances of this screw are the focus of the present invention. Thus, and also because our invention applies beyond the field of prosthesis, we will also call this screw the main screw. We will call the pierced element of the prosthetic abutment the trans-screwed element or trans-fixed element: it is all or part of the abutment in the context of oral implantology, depending on the details of the technique being used.
2): Sealing of a ceramic element to the trans-screwed piece.

When considering our invention in a broader context, the implant is taken as an example of support for trans-screwing: clearly, trans-screwing extends much beyond being the first part of screwing-and-sealing, which is the role it plays in the context of implantology.

In the sequel we shall often use prosthesis as short for a “prosthetic artifact that gets attached to the crestal end of the implant”, (we also say “above the implant”) or for an appropriate combination of such artifacts: oral surgeons will easily recognize the artifacts that are appropriate for each case: otherwise speaking, the implant itself is not considered as prosthesis, but as support for the prosthesis, a terminology preferred by some and to which we will adhere.

Remark: For definiteness, the orientation of teeth and implants will be fixed so that the root of a tooth is considered as being below the crown, even if one deals with a tooth or implant to be implanted in the upper jawbone. Translating the layman language to the dentistry specialized jargon, with such convention on the orientation, the bottom thus corresponds to the apical end (the extremity of the root), and the top to the crestal end (the extremity of the crown). We will use any wording indifferently so that some of the teaching of the present invention can be used more easily beyond the fields of implantology, or at least in implantology in general surgery, beyond the sole field of dentistry.

At the time of writing of this invention, the attachment of the prosthetic abutment to the implant is most often achieved by screwing a metallic screw (the trans-fixation screw) to which a maximal force somewhere between 15 and 25 Newtons/cm is applied (although some use higher forces, for instance to try solving the problem we consider here by using Morse cones). The problem that is left open by this way of securing the prosthetic abutment is that it does not remain stable as time elapses. The fact is that under physiological occlusal conditions (i.e., in particular, conditions that makes the teeth operative, hence subjected to a variety of forces due to the normal interaction with other teeth), the micro-movements induced by mastication can cause some unscrewing of the trans-fixation screw. This loosening of the screw is enough to be harmful to the stability of the overall prosthetic construct: the consequence of unscrewing of the trans-fixation screw can lead to catastrophic incidents, including the fracture of the prosthetic abutment, hereby preventing from putting the implant in charge. It is clear that the problem of lack of stability of fixation by means of a screw, that we just described in a precise context where it is particularly relevant in the framework of implantology, also arises in many other situations. These are conditions where, like in implantology, securing is achieved through a screw that one cannot (or does not want to) access by the side nor access from beneath. We will define:
access by the side as an access that is along an axis that is neither parallel nor almost parallel to the axis of the screw,
and access from beneath as an access such as when one uses one or more bolts, i.e., by approaching along the axis of the screw, but with the orientation reverse to the one of screwing.

The “neither by the side nor from beneath” constraint in the case of attaching the prosthetic abutment to an implant is due to the fact that such approaches would be quite exceedingly traumatic, and would entail severe destructions in the bones in the vicinity. Altogether, the problem of stabilization of the trans-fixation screw is made hard by many requirements formulated here in the context of implantology, but which are encountered in many other applications:
I) There is an uncompromising need for reversibility, i.e., the dentist must be able to undo the screwing as the prosthetic abutment is the weak part of the assembly and may need to be replaced without having to change the implant.
II) Also, because some implant are in environments that prevent the use of excessive forces, the blocking of the trans-fixation screw should not be obtained by forces beyond what is needed for the rest of the work.
III) Furthermore, teeth are subject to many forces, specially pushing them along the axis from the crown to the root. As a consequence, a system than would prevent the trans-fixation screw from getting unscrewed, except when it is pushed down along that axis is not acceptable as one could expect that random forces then easily cause unscrewing to occur.
IV) The “neither by the side nor from beneath” constraint described above.

The problem of the stabilization of the attachment of the prosthetic abutment to the implant is considered by many surgeons as the last big issue to be solved in a convenient and general enough manner, and has attracted much attention. However most solutions involve major changes in the overall system rather than focusing on a mildly adapted screwing system. For instance, in U.S. Pat. No. 6,663,389 issued on Dec. 16, 2003 to Gallicchio, and entitled “Implant for artificial teeth”, a description of an overall solution for the implant and the basis of the prosthetic abutment is described, so that rotation of the abutment with respect to the implant is mostly avoided. Similarly, in U.S. Pat. No. 5,823,776 issued on Oct. 20, 1998 to Duerr et al., and entitled “Enossal single tooth implant with twisting prevention”, are described specific implants in which a solution to the problem is proposed. Again in the same vein, in U.S. Pat. No. 6,102,702 issued on Aug. 15, 2000 to Folsom, Jr. et al., and entitled “Quick tightening abutment lock”, it is the abutment lock that is revisited. Such solutions cannot satisfy most users because most dentists practicing implantology have formed some serious bounds with existing types of implants on which depends the quality of their work and their overall professional efficiency. Thus a solution that could be implemented by requiring only small modifications to a great number of implants models (existing or to come) would be most welcome by the profession. This is the central contribution of the present invention, where instead of reconsidering the overall implant-prosthetic abutment, we concentrate on efficient solutions to the reversible stabilization (in the sense discussed below) of the trans-fixation screw, with applicability to other domains. The invention indeed proposes an analysis of what we call absolute and relative blockage of the trans-fixation screw, and when relative blockage works as well it allows us to present a variety of solutions. Given the state of the art, and when restricted to implantology, this invention focuses only on reversibly stabilizing the screwing quality of the trans-fixation screw in order to solve the global rotational stability of the prosthetic construct on top of the implant rather than on proposing a completely new system.

As much reversibility as possible is often a golden rule, in particular in dentistry as we have said, but in other fields in implantology and beyond as well. The solution of riveting is not applicable because of the combined demand of solidity and reversibility, even assuming that rivets could be used as securing mean. Thus the -present invention importantly satisfies the need of possible re-intervention and preserves the deconstructibility of the system built on top of the implant (i.e., the capacity to undo whatever is done there without excessive work nor any significant needed damage). The invention solves the following practical paradox:
“Although the trans-fixation screw is blocked against any accidental unscrewing, the practitioner will be able to unscrew it without having to break anything (or anything of relevance), and the practitioner will be able to disassemble the system each time it is needed—and then re-screw the same or another prosthetic abutment as appropriate.”

To illustrate the difficulty of the problem solved by the present invention beyond the practical paradox that we have mentioned, let us recall that even filling the inside of the prosthetic abutment with resin does not suffice to prevent the unscrewing of the trans-fixation screw (the filling is often done nevertheless, be it only to slow down the undesired unscrewing).

Because of the discovery of osseointegration (i.e., the strong bonding of living bone tissues to titanium and some alloys such as Ti6Al4V) in 1952 by Professor Per-Ingvar Branemark, and the observation that mono-metalism (the utilization of a single metal) is greatly more appropriate, titanium-based mono-metalism has become one more constraint to acceptability of any solution to the problem of the stabilization of the main screw in the context of oral implantology. Given the solidity and eleasticity properties of titanium, all aspect of our invention can be implemented while respecting titanium (in pure or alloy form) mono-metalism.

### BRIEF SUMMARY OF THE INVENTION

The main idea of this invention is to provide a reversible mean to bloc a screw without accessing it, neither by the side nor from beneath (where by reversible we mean that the blockage can be removed at will while it is safe to consider that it will resist any accidental unscrewing). There will be two (non-necessarily mutually exclusive) types of solutions proposed:

Type 1, where a mean is provided that blocks the screw to be blocked as long as said mean is not fully de-activated. For instance a mean is provided that blocks the screw to be blocked so that de-acting it without holding said screw would force said screw to get even more screwed. To support the value of this instance of Type 1, we notice that such further screwing is essentially impossible when said screw is forcefully screwed or screwed into a threaded chamber that has a bottom as is the case for most if not all trans-fixation screws used in implantology.

Type 2, where a mean is provided that blocks the screw to be blocked so that de-acting said mean necessitates a quantum leap in some stress that can be exerted without problem by a qualified human agent but cannot occur accidentally within (and even far beyond) normal utilization conditions.

Otherwise speaking, in Type 1, there is a quantum leap in on how much of the blocking mean must be undone to free the main screw, while in Type 2, the quantum leap is in what is needed to undo the blocking mean. Said quantum leaps are what basically allow one to overcome the practical paradox that we have previously mentioned.

Notice that Types 1 and 2 are not mutually exclusive, and we will say Type 3 each time the solution
Either is of both types at once (as for instance if using both kinds of blockers in conjunction or in fact using only a post in the first method),
Or can be specialized to any of Type 1 and Type 2 by specifying some details (as before one decides on a screw or post in the first method).

The solutions will be presented, grouped by methods, where two different variations of the same method, that are very similar in many respects, can still belong to different types as we have just defined. This is the case for the two main variations of the first method that we will present for instance. Every method will lead to define systems that we will describe in details.

The first method proposed in this invention on solution of the stated problem of stabilizing screws in a reversible way, respecting constraints I to IV formulated above, consists in:
Equipping the trans-fixation screw, or more generally any screw that is the primary screw to be screwed and called the main screw—of which the trans-fixation screw from the implant context are our main example—with one or more blocking screws and/or with one or more blocking posts (we will say blocker or blocking device when meaning any of a blocking screw or a blocking post),
And equipping the solid body that contains the threaded chamber that receives the main screw (or possible the threaded bottomless hole when not dealing with an implant context) where said main screw is to be screwed, with one or more holes called blocking holes and correspondingly equipped.

Here:
The word “correspondingly” means here that said blocking holes will be threaded when the blocking devices are screws, and equipped in a way adapted to the way the post has been designed (we notice not all holes need similar equipment: for instance in mechanical contexts when there are several different sorts of stress to be overcome, different holes may be equipped differently to ensure simultaneous protection against many causes of unscrewing).
The name “main screw” comes by opposition to any other screw that might be used to block or for other reason, such as the blocking screws that we have mentioned.
Whenever the blocker is a screw, that screw is preferably screwed in the sense where the main screw get unscrewed, and vice versa (i.e., that screw is screwed counterclockwise if the main screw is screwed clockwise and that screw is screwed clockwise if the main screw is screwed counterclockwise), as long as the blocker interacts only with the head of the main screw but not with the body of said main screw.
Notice that this method is of Type 1 when the blockers are blocking screws, and mostly of Type 2 but also somewhat of Type 1 if the blockers are posts: we thus see that the first method is of Type 3, so that a mixed type method can indeed be found.

The first main idea behind the first method is that, while the main screw is expected to secure tightly, the blocking device (or plurality of blocking devices) just needs to not be fully undone except willingly. Further ideas depend on precise realizations and should be easy to abstract by whoever would be interested from the precise descriptions to be provided later on.

In the case when the blocker is a blocking screw, we distinguish two sub-cases;
Either the blocking screw screws the head of the main screw but stays away from the body of the main screw, in which case it is plain that reversibility is not an issue, as unscrewing the auxiliary screw will not even necessitate the main screw to be held during the operation (the draw back then in the case of application to implants is that this configuration may force the auxiliary screw to be quite small). In this case the blocking screw will preferably screw in the unscrewing direction of the main screw, as was said.
Or the body of the main screw is hollowed and the cavity threaded so that the auxiliary screw is screwed into a threaded chamber some walls of which are from the implant and the rest from the screw, in which case the auxiliary screw can still be screwed and unscrewed at will, but the main screw needs to be kept in place during the operation, specially while screwing the auxiliary screw to prevent the main screw from being unscrewed. In this case the blocking screw will preferably screw in the direction of the main screw (i.e., in the direction where one screws the main screw).

In both sub-cases, unscrewing of the blocking screw hints at screwing further the main screw, and is hereby prevented, while the main screw simply cannot get unscrewed as long as the blocking screw is at least partly in place (thus we are in a Type 1 situation).

The two sub-cases that we have discussed for screws also arise when the blocker is a blocking post, but there is no issue to be discussed then in relation to the direction of screwing. In the case when the blocker is a blocking post, the reversibility comes from the possibility of taking off the post. There may be instances where the post can as well be easy to put in place and to pull out as for instance gravity keeps it in place except otherwise decided. More often, the post will be equipped with a system that keeps it in place and must be released before the post is pulled out: for instance we can make sure that a spring releases a side extension of the post when it is in place and that by pulling a ring attached to the head of the post, the surgeon (or more generally the professional in charge) causes that side extension to vanish and then permits to pull out easily the post.

In order to:
Ensure more efficiency of the way the different pieces get to the right spot,
And let in particular the post get in the right hole at the right time, the head (i.e., crestal end) of the post will for instance be set on top of a thinner collar around which a clamp will stay in place until, when screwing the main screw, one gets said main screw to reach close enough to its proper spot and said post to come close enough to its designed blocking hole (recall that there might be several blocking holes; this may happen as different options for a given post or screw or one per blocking device, with all possibilities in between). The same sort of clamp will be possibly used as well in the case when the blocking device is a blocking screw, the collar part being then the main body of the blocking screw. When the clamp is off the blocking device, a spring or outside intervention can then push the device into (or partially into) the appropriate blocking hole. By avoiding equipping the apical end of the auxiliary screw with threads, that screw will somehow behave like a post as far as being able to be pushed into the appropriate blocking hole is concerned.

In the case of implantology, the fact that the implant is located in the upper or lower jaw will not cause any particular difficulty as far as getting the device engaged into the proper devices, thanks to a spring that will push the device toward the apical end as soon as the device will be aligned with a blocking hole with the clamp removed. This spring-clamp technique of combined usage of:
a spring to push (or pull) devices into their blocking place,
and a clamp to prevent such push or pull to occur until the right time.
   This technique, like other aspects of the invention, is expected to find applications beyond oral surgery.

We speak of absolute blockage when the main screw is blocked with respect to the support, i.e., the medium carrying the apical end of its threaded chamber (we will say “chamber” whether there is a bottom wall or not), for instance when the trans-fixation screw will be blocked with respect to the implant. We speak of relative blockage when the main screw is blocked with respect to the trans-screwed element (the element—e.g., the prosthetic abutment in dentistry—that the main screw attaches rigidly to the support—e.g., the implant in dentistry—of the apical end of its threaded chamber). These two forms are mostly equivalent in the case that we call contact blocking when the trans-screwed element cannot turn or otherwise move with respect to the support as long as the screwing is tight enough, something that can be achieved by equipping the trans-screwed element and the support with complementary grooves and protuberances: for instance an hexagonal hole in one of them and the corresponding hexagonal embossment, so that the embossment gets trapped in place in the hole as long as the screwing is reasonably tight. We will say that the blockage is mixed if it is both absolute and relative, but will also then say absolute as we consider absolute as being better, and the best quality is what counts in most case.

Remark: Contact blocking is easily implemented as we have explained. Consequently, it will be assumed that contact blocking is in place when needed.

We then see that the solutions of the reversible screw blockage described so far are absolute, and in fact more precisely mixed if the holes through the trans-screwed element are just of the size allowing the blocking device to pass through. We also notice that in the case of implantology, one can always assume that contact blocking is in place since this is easy to impose without sacrificing anything important, so that the methods above can be easily made relative by using shallower blocking holes that do not penetrate the support: one advantage of such relative blocking is that the holes can be made at a later stage of the overall process, after many customizations have been performed if needed.

We next propose a first method to ensure relative blockage, which could be enacted in the context of implantology. According to this method which is of Type 2, the head of the main screw carries latches that are attached with some elasticity along the radius of the main screw head so that some little side post around the threaded chamber (or a plurality of such side posts) blocks unscrewing by catching the latches, but the latches are so profiled that they are pushed inward along the radius thanks to the elastic attachment when screwing. When one needs to unscrew, a special tool will catch the wings and bring them in along the radii (for instance by compacting their elastic roots) so that the little posts are not anymore obstacles to unscrewing, as long as the screw is unscrewed using said special tool. Further variations on the theme of the cancellation of the blocking effect of latches when one wants to unscrew are easily provided: for instance, the latches are also attached with elasticity in the direction of the axis of the screw, and one pulls them upward, above the level of the side posts, to unscrew. By piercing the trans-screwed element with appropriate holes, so that said side posts be in fact attached to the support and pass through said holes, one turns the relative blockage that has just been described into an absolute blockage.

A somewhat different sort of Type 2 blockage is obtained by using an element such as a device, or a strip, or a rod, that comes to cover the head of the main screw once it is screwed in place and gets captured by a system of portals or another trap, the securing of the positioning of said element being obtained by combining geometrical features of the portal and the element. The portal or other trap for keeping the blocking element in place is either attached to the trans-screwed element (relative blockage) or traverses it, thus being attached to the support (absolute blockage). The element is put in place using brute force and its elastic properties, or turns around an axis that is part of said portal. Special tools that allow to handle the element and help putting them in place or taking them of, while essentially canceling the risk of said element falling in a patient's mouth in the case of implantology are easily designed, at least for some basic types of elements: if the element is not attached to some bigger piece of the prosthetic ensemble, it is advisable that the element be securely clamped by the special tool when not blocked by the portal or other part of the overall system.

### BRIEF DESCRIPTION OF THE SEVERAL VIEWS OF THE DRAWINGS

The principles and main advantages of the present invention will be better understood on examples illustrated by the figures to follow, where:

FIG. 1 represents in A and B schematized implants that correspond to the state of the art prior to the present invention, with a global view of an implant and trans-fixation screw in A. Also in part A are magnified side views of the implant heads of the two basic models, with some transparency for one model to see a hole in the head of that model and to show the main screw, while the other model has a protuberance and transparency is used only to show the main screw. Both models offer the same view from above, shown in part B. The polygonal shape of the hole or protuberance helps contact blockage, and the number of faces of the polygon is about 6 but not necessarily equal to six: six has been chosen here with no intent of limitation, as the number of faces for all illustrations where some choice of the polygon had to be made. Sizes, angles, and ratios of sizes of the elements are arbitrary, in A and B as in most drawings: the sizes, angles and ratios are chosen for the purpose of easy drawing rather than for realism. However part A′ of FIG. 1 is giving size ratios quite different from what is shown in parts A and B and in fact quite close to what one finds in dental implantology: the dental surgeon and other users will easily recognize in further figures what is at the right size or proportion. In part A5, one suggests using iteration of the method.

FIG. 2 represents features that pertain to the general issue of the positioning of a blocking screw with respect to the trans-fixation screw, taken as example of a general main screw, and with respect to the implant, taken as an example of support.

FIG. 3 represents in A possible positions of blocking screws and in B possible positions of blocking posts.

FIG. 4 represents a variety of shapes of heads of main screw in part A, without attempt at being exhaustive. In part B it illustrates how a blocking post can be put in place relative to a main screw. In part C it represents means to get the blocking device into the blocking hole, and in part D, means to lock and release a blocking post into a blocking hole.

FIG. 5 illustrates in part Z the principle of the first proposed method of relative blockage that sometimes can also be used for absolute blockage, and in parts A and B the basis for realization of said principles.

FIG. 6 illustrates respectively in parts A and B, more explicit instances of the examples that are described in parts A and B of FIG. 5.

FIG. 7 builds on what is presented in FIG. 6 to illustrate in parts A and B even more explicit instances of the examples that are described in parts A and B of FIG. 5, now in the context of implantology. In A′ is presented the absolute blockage that corresponds to the relative blockage system illustrated in part A.

FIG. 8 represents in A the second class of techniques proposed for relative blockage illustrated by a first example in the framework of implantology, and in A′ the corresponding absolute blockage.

FIG. 9 represents an adaptation of the first example of the second class of techniques proposed for relative blockage as shown in FIG. 8 to a system very particular to dental implantology or to applications with similar geometries.

FIG. 10 represents again the second class of techniques proposed for relative blockage, but illustrated here by a second example in the framework of implantology.

FIG. 11 represents an adaptation of the second example of the second class of techniques proposed for relative blockage as shown in FIG. 10 to a system very particular to dental implantology or similar geometries.

FIG. 12 represents details of a hollowed main screw and the threading of the hollowed part, before the blocking screw is in place.

FIG. 13 represents details of a hollowed main screw, with the blocking screw is in place.

FIG. 14 shows how to adapt the situation in FIGS. 12 and 13 to the case when the hollow part of the main screw is not easily adjustable to fit perfectly with the blocking hole.

FIG. 15 represents a tool that allows one to use pairs of screws as illustrated in FIGS. 12 and 13, even if said screws are quite tiny as would be the case in the context of implantology. That tool is easily adapted to replace the blocking screw by a blocking post.

### DETAILED DESCRIPTION OF THE INVENTION

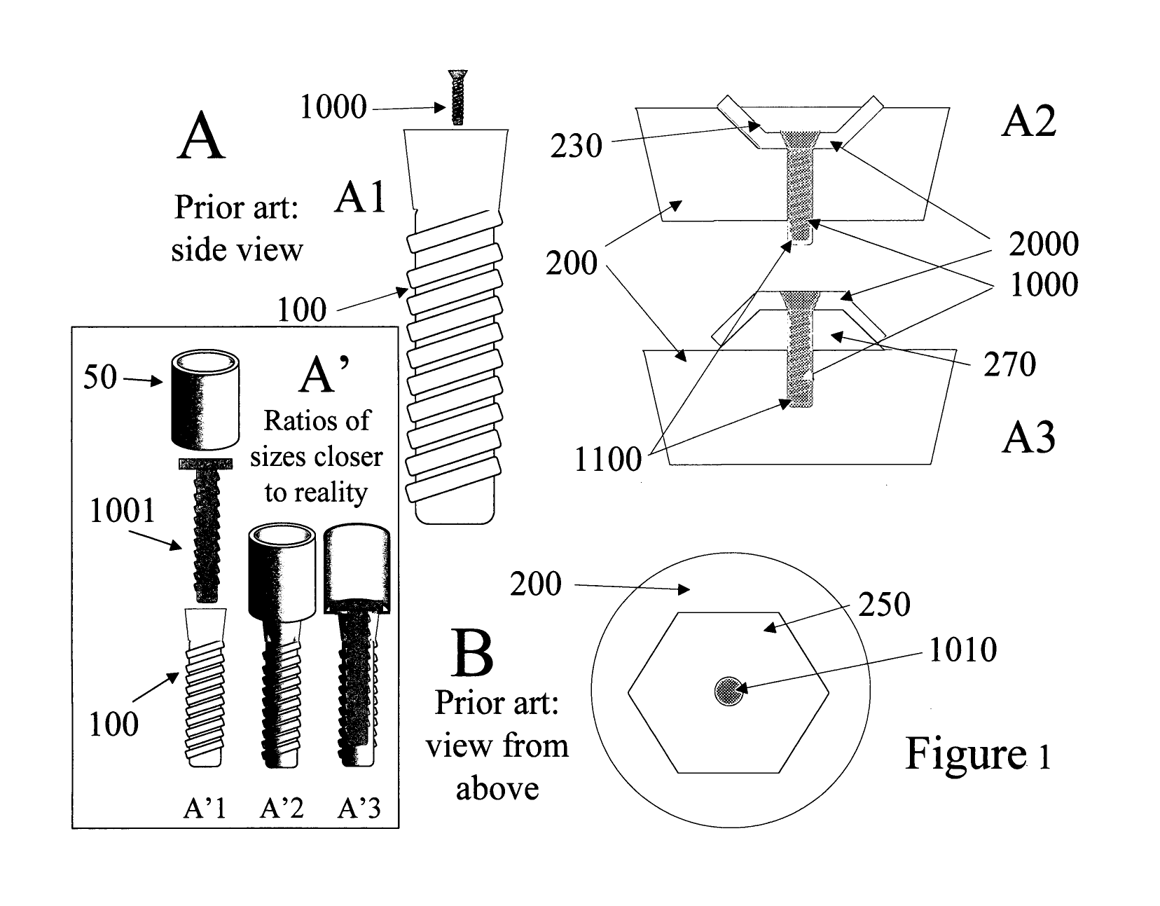

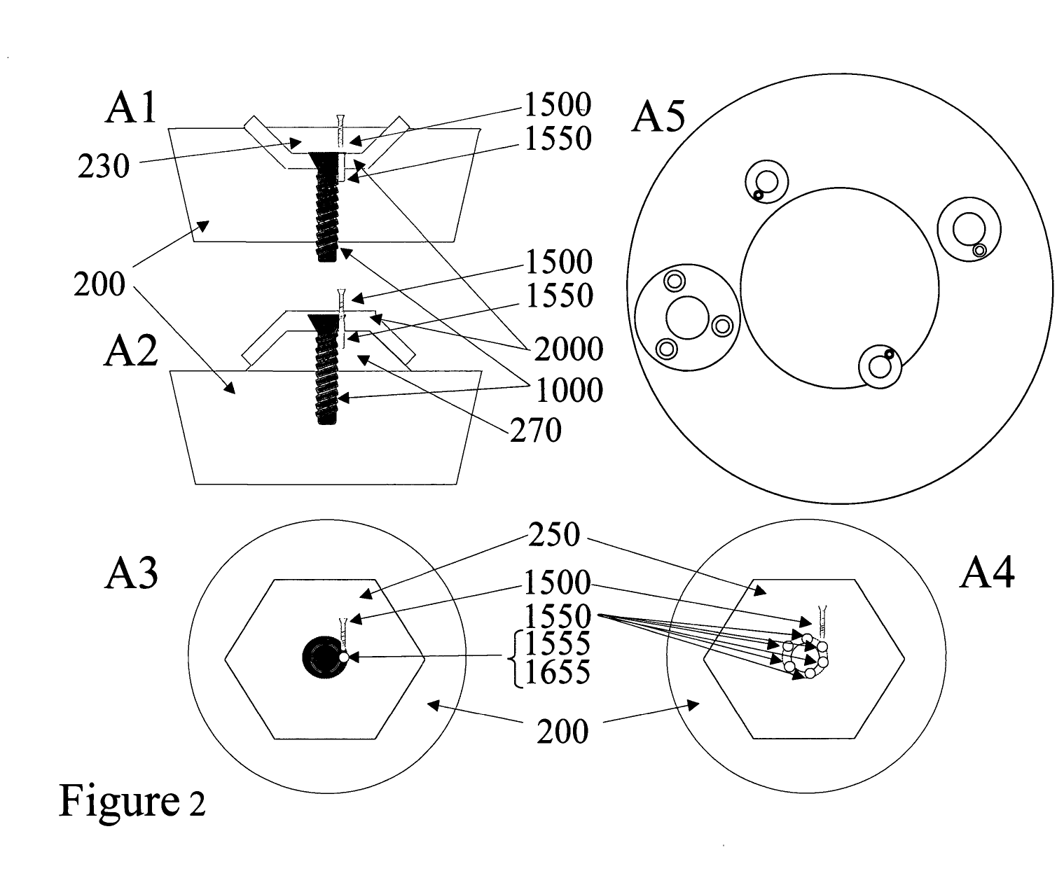

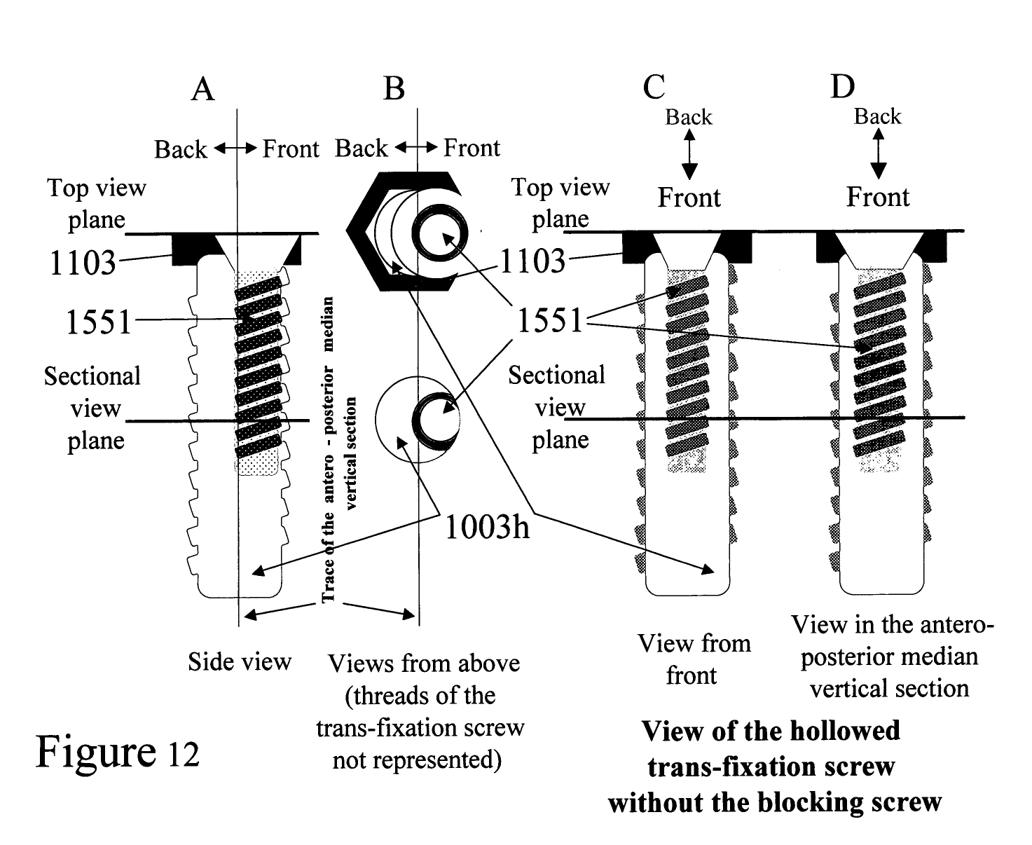

After the stage is set using FIG. 1, several methods will be proposed. First, a method for Type 3 that easily specializes to Types 1 or 2 will be presented using FIGS. 2 to 4 with further details on an important special case relegated to the end of the discussion, using FIGS. 12 to 15. Two methods of Type 2 will be presented is some preferred embodiments using illustrations in

With reference now to FIG. 1, which helps us set the stage by schematically presenting elements as they are used in prior art, we see:

In part A on the left of the figure (sub-part A1), the schematic view of a typical dental implant at 100 and of a trans-fixation screw at 1000: to illustrate the arbitrary character of the sizes, angles, and relative sizes that will be used for the purpose of illustration except otherwise specified, quite different size ratios between the implant and the trans-fixation screw are used in the inset A′ to FIG. 1 (where a different main screw's head is used so that the main screw is referred to as 1001 instead of 1000: 1000 may still serve as a generic designation or for a main screw).

Part A′ of FIG. 1 is indeed using size ratios quite different from what is shown in parts A and B and in fact ratios that are quite close to what one finds in dental implantology: dental surgeons and other users will easily recognize in further figures what is at the right size or proportion and which of the drawing only convey the topology rather than the geometry of the invention. Part A′ also show a schematic abutment at 50, and the way it attaches to the implant, by an analysis of the elements in A′1, a side view of the assembly at A′2 and a median vertical section at A′3.

The side-view magnifications of a implant's heads, with transparency for sub-parts A2 and A3 of FIG. 1, and in part B a top-view magnification of an implant's head, jointly allow to see:
at 200 magnified views of the implant's head, an implant head being a particular case, found in the context of implantology, of the support (or medium or basis) in which things get screwed,
at 2000 tiny portions of the trans-screwed element. The represented tiny portion of the trans-screwed element extends to a scale of the same order of magnitude as the scale of the implant to form the lower part of the prosthetic abutment on top of which a ceramic tooth (as most frequent best choice) is later sealed),
at 1000 the trans-fixation screw,
at 1010 the threaded chamber for the main screw,
at 230 on part A2, 250 on part A3, as well as at 270 on part B that relates to a view from above of the implant's head (in both sorts represented in A2 and A3) a cavity (for the sort in A2 that we will call shape C implants) or protuberance (for the sort in A3 that we will call shape P implants) whose sections orthogonal to the axis of the screw are hexagonal as shown at 250 in the top view in B, but which could as well be otherwise polygonal (although small numbers of sides are preferred, and regularity of the polygon is often imposed, although not always necessary). The convention of using reference 250 to designate the top view of either 230 for shape C implants or 270 for shape P implants will be used implicitly whenever needed in the sequel. The polygon will be used as contact between the implant and the part of the prosthetic abutment attached to it by the trans-fixation screw (and more generally between the support and the trans-screwed element), as the male element for shape P implants and as female element for shape C contacts. Such polygonal contact will allow any relative blockage to be as secure to absolute blockage as discussed in the comparison between absolute and relative forms of blockages.

With reference now to FIG. 2, we see at 2000 a fragment of the trans-screwed element, and at 1500 a blocking screw according to the present invention. We indicate at 1550 the position of the blocking hole in the implant, or the position of several of them as in part A4 of FIG. 2, which is a view from above. Such positioning indicated here in the case when the blocking device is a blocking screw would work as well in the case of blocking posts that we will illustrate with more details later on. Thus, the blocking screws in FIG. 2 should be understood as being examples of blocking devices: all that is represented would work similarly with blocking posts instead of blocking screws. We have represented the position of the blocking device with the two shapes, shape C and shape P, of implants, respectively in parts A1 and A2 of FIG. 2. We have arbitrarily chosen to illustrate different states for the two shapes, although the other choices would have worked as well, but we did not want to duplicate elements that are easily adapted from one shape to the other. Thus we see a screw not yet engaged in the blocking hole for shape C (as indicated by the relative positions of 1500 and 1550 in A1) since this is one way in which the blocking screw can be at the time when initiating its placement, and a screw partially engaged in the threaded blocking hole in A2 for shape P, but engaged in the trans-fixed element only, since this is another way in which the blocking screw can be to when initiating its placement. The blocking screw can also, as a third possibility, come loosely attached to the main screw: this is in fact one of the ways the blocking screw may be delivered to the dentist in some packaging options for the present invention. Attaching loosely the blocking screw or the blocking post to a larger element before getting it to its final position is indeed an option that may be preferred to simplify its manipulation, especially when the blocking device is quite small: the same apply to other small blocking accessories that we will see all along. In the two views from above in FIGS. 2-A3 and 2-A4, we have used again the convention of writing 250 to designate either 230 or 270 depending on which shape (C or P) is being represented, as the shape does not matter for what is figured in A3 and A4.

On the bottom left view (FIG. 2-A3), 1555 represents the part of the blocking holes for the blocking screw that is inside the head of the trans-fixation screw, assuming there (to the contrary to what is figured in parts of A5) that the blocking holes stays clear from the body of the main screw, an assumption that we will remove in some preferred embodiments that will be discussed in details later on: we also use 1655 as this is the label that would be proper in the case of the part of the blocking hole inside the head of the main screw in the case when the blocking device is a blocking post. We have figured many holes in part A4 but there might either be one, or several blocking holes. In the case when many holes and many devices are to be used, one may either wish that all devices get into any of the holes or not. If not, one may have several sizes, or even different section shapes for the devices and correspondingly for the blocking holes, so that each device can only get into the holes with sectional shape compatible with its own sectional shape.

Also notice, with reference to A5 that the method 1 can be iterated, at least for very large screws, as the blocking screw can be considered as a new “main screw” and be secured by small blocking devices, and so on as long as screws are used at the next scale and the size is not yet too small. In industrial applications, this iterated process may help protecting against unscrewing factors in some wavelength range by iteratively transporting the problem to many ranges that may include wavelength that are less dangerous, and by protecting anyhow against sets of unscrewing factors that does not act simultaneously on many ranges (whence the suggestion in A5 to use blocking devices of many sizes together). The system obtained by iterating method 1 will be obvious to anyone skilled in the art of mechanics or mechanical engineering. The method and system van also use one of the other methods for smaller scales.

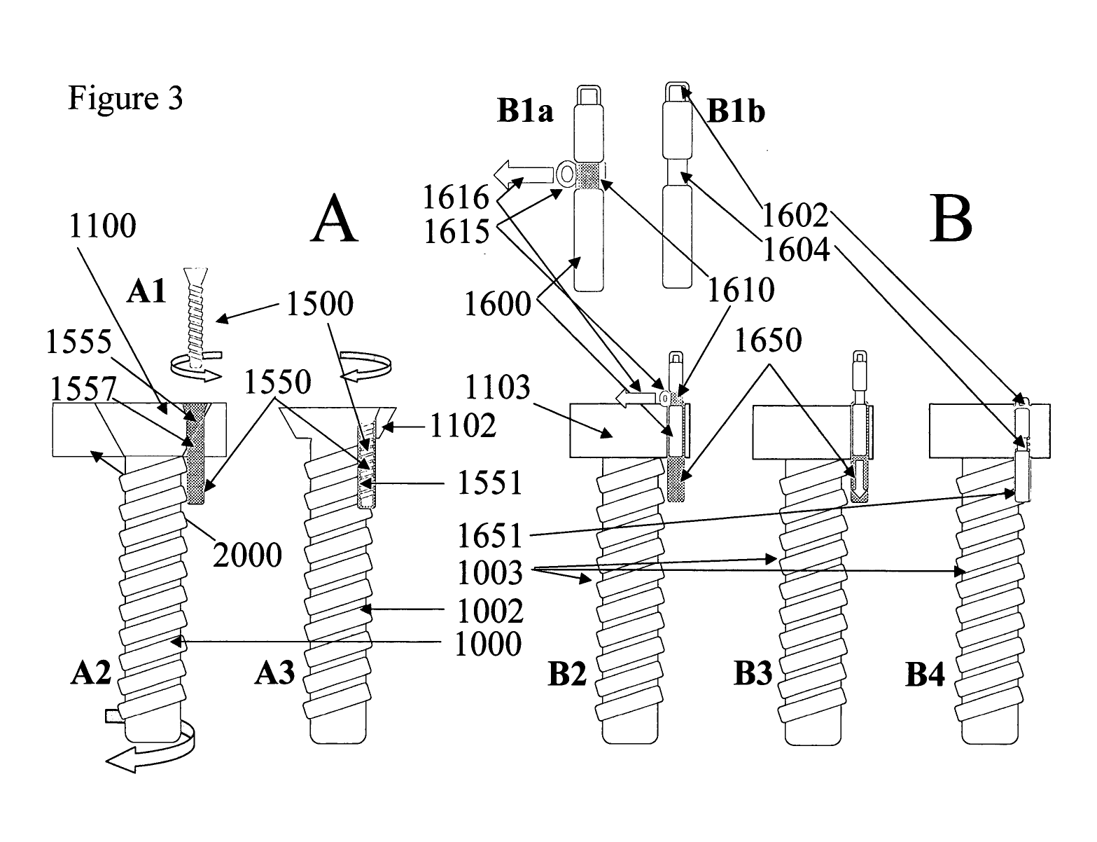

With reference now to FIG. 3, part A of that figure is devoted to the case when the blocking device is a blocking screw, while part B deals with the case of a blocking post.

In sub-part A1, where the blocking hole pierces the head of the main screw but stands clear from the body of that screw, we indicate by the round arrow around the blocking screw 1500 (which round arrow is to be compared to the round arrow at, the bottom of sub-part A2 and describing the screwing direction for the main screw 1000) that the blocking screw will preferably be screwed in the direction opposite to the screwing direction of the main screw: this will cause accidental unscrewing of the blocking screw to screw further the main screw, but as that one is assumed to be screwed essentially to the maximum, this choice of mutual orientations for screwing the main screw and the blocking screw will let the main screw prevent in large part the unscrewing of the blocking screw. Since on the other hand, the blocking screw prevents the main screw from accidentally unscrewing, the system hereby presented is one mean to achieve the goals of stabilizing the main screw. Next we remark that, holding if necessary the main screw in place, one will be able to willingly unscrew the blocking screw. After that unscrewing is achieved, it will become quite feasible to unscrew at will the main screw, so that the system that we have presented does solve the stabilization to unwanted unscrewing while permitting reversibility and for instance allows dismounting in the context of implantology.

In sub-part A2, we have presented the three parts of the blocking hole: going from the crestal end toward the apical part, there is at 1555 the part in the head of the screw, at 1557 the part in the trans-fixed element 2000, and at 1550 the part in the support (although the support itself has not been represented, as its position near the main screw should not be ambiguous). In order to take full benefit of the mutual interactions between the main screw and the blocking screw described above, the part at 1555 will preferably be threaded. To the contrary in most cases one may prefer to not thread the part at 1557.

In sub-part A3 is represented a case when the blocking hole eats part of the body of the main screw (compare with an identical situation in sub-part B4 in the case of a blocking device). The cavity or hollowness in the body of the main screw will then possibly be threaded, as will be detailed later on. In fact both parts 1555 and/or 1557 may also be threaded when 1500 come in part in the body of the main screw. Notice that the curved arrow at the top of the blocking screw in sub-part A3 indicates that if 1500 has a part that is a cavity or hollowness, one may chose to screw the blocking screw in the same direction that the main screw, and even more so if 1555 is not threaded.

Turning now to part B of FIG. 3, we see in sub-parts B1a and B1b a blocking device shown with a magnification larger than in the rest of FIG. 3 to show more clearly the neck at 1604, the clamp at 1610 with the clamp's ring at 1615 whose role is to help the surgeon pull the clamp at the appropriate time (i.e., while screwing the main screw, when said main screw comes close to the desired position so that the post should get in the next blocking hole of it's size—and/or shape as discussed previously—on it's way), and the post's ring at 1602 whose role is to help the surgeon easily pull out the post if dismounting is needed and the surgeon (as an exemplary user of the invention) wants to unscrew the main screw (more on possible use of the post's ring will be discussed later on). When 1610 is pulled off (for instance by puling on its ring 1615 as indicated by the fat arrow at 1616), one passes from the configuration in B1a to the configuration in B1b (or from the configuration in B2 to the configuration in B3). The blocking post 1600 then becomes free of getting pushed into a blocking hole as soon as it is aligned with one of them (more precisely one of them in which it can fit, in case many shapes of posts are used). A blocking post 1600 inside a blocking post that can host it after removal of the clamp 1610, is shown in sub-part B4 of FIG. 3, which is also distinguished from sub-parts B3 and B2 by the fact that a portion 1651 of the blocking hole occupies part of the location of the body of the main screw. Details of this configuration will follow. Notice that arrow 1616, along which clamp 1610 is pulled off (possibly by seizing ring 1615 for instance with the help of a small hook), is oriented toward the center of the main screw as this is one direction inside the prosthetic tooth to be screwed to the implant from where the surgeon will find room to pull the clamp; tangential pull would be possible but pulling outward along the radius might only be practical in contexts other than dentistry. Also notice that the main screw 1002 in A3 and 1003 in B2, B3, and B4 has a head different from that of the screws at 1000 or 1001 in FIG. 1, this is done to indicate that the invention works with any geometry of screw heads, with some variation such as the main screw being hollowed working as well for headless screws (most often not used for trans-fixation, as it is usually the head of the screw that holds the parts to be transfixed, except possibly if the transfixed element holds part of the threading for the main screw).

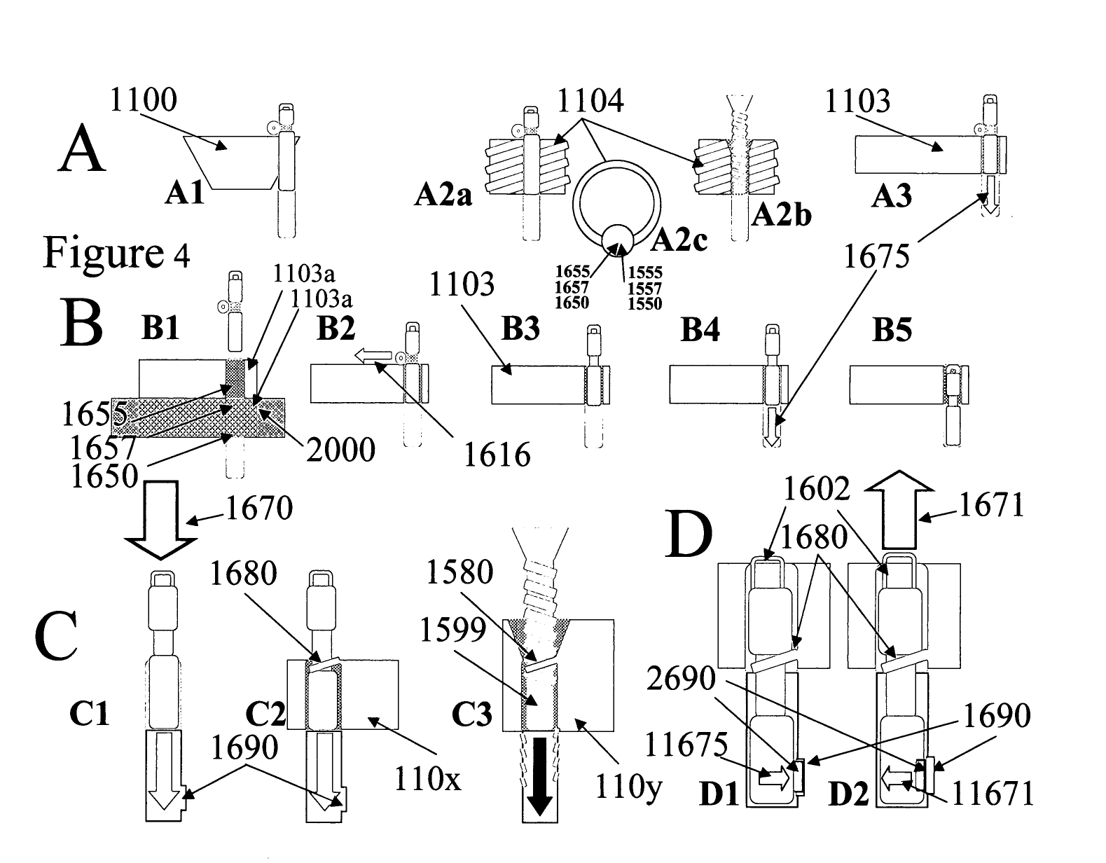

With reference now to FIG. 4, we see in part A several shapes for main screw head (at 1100, 1104, and 1103, where 1110x is the name for the head of the main screw sort with label 100x) with means to associate to them some blocking screws or blocking posts that will be set in blocking position after adequate screwing of the main screw that brings the blocking device to the access of the blocking hole (or to the appropriate blocking hole in the case several blocking holes are being used). In A2a and A2b we both used a blocking post and a blocking screw (respectively in A2a and A2b) to illustrate the fact that some essential aspects of the first method do not depend on the fact that the blocking device is a screw or a post. The choice of main screw head at 1104 is in fact the absence of a proper head, so that the threading goes up to the top of the screw (which we indicated as improbable for trans-fixing in implantology, but the applicability of the present invention on screw stabilization being not limited to implantology, nor even to tran-fixation screw, we purposely use here a quite different geometry of main screw from what was used so far). Anyway, when there is no proper head, one has to (and in other cases one can) arrange the blocking hole so that it gets into a hollowness of the main screw's body, as seen in the top view A2c where:
the outer circle is the footprint of the threading,
the inner big circle the footprint of the main body of the main screw.
and the disk marked both 1655, 1657, and 1670 to indicate the footprint of successive layers of the blocking hole in the case of a blocking hole for a blocking post, and also 1555, 1557, and 1570 to indicate the common footprint of successive layers of the blocking hole in the case of a blocking hole for a blocking screw (numbers that where previously used in FIG. 3-A2 on the lateral view of a main screw of geometry 1000 for the case of a blocking screw, and that are used in a lateral view with a blocking post on FIG. 4-B1). When the blocking device is in place, the three layers of hole get aligned, with some of them getting in coincidence for the case 1104 and for head 1103 (used in B1) as well, which is why one has a common footprint in A2c.

Still on FIG. 4, but now in part B, we have only used main screw heads of geometry 1103, but this is just for illustration purpose, and once more, the choice being made should not be understood as a limitation. In B1 we have represented the various parts of a blocking hole for a blocking post, and also indicated that the initial way in which the blocking post can be presented may be as separated from all other part, a solution which may be preferred if all parts are large enough, but that may not be preferred if the post is small as it would be for applications to implantology. Thus 1655 is the part of the blocking hole initially in the head of the main screw, 1657 the part initially in the trans-screwed piece, and 1650 the part in the support. In the view B2, the post has been put in place in the part of the hole 1655 by the user, or is delivered that way. The post does not go further toward the apical part as long as the clamp is in place, which is taken of by pulling at 1616 as described previously when commenting FIG. 3. The clamp has thus been taken off at B3, which indicates that one comes close to optimal screwing of the main screw, as described with details previously, and in B5, the blocking post has gotten in the full extent of the blocking hole.

Sill on FIG. 4, but now in part C, we see in C1 that the push 1670 on the blocking post (or screw, not presented here) toward the apical end can be exerted in many ways, including a spring appropriately placed in the blocking hole (assuming the main screw is delivered, e.g., to the oral surgeon, with the blocking device attached) as represented at 1680 for a spring acting on a blocking post and at 1580 for a spring action on a blocking screw, when the blocking screw has been built without threading at the apical end as represented at 1599 (in part C3 of FIG. 4) so that as far as pushing it in place in the blocking hole, the blocking screw behaves in the same way as a blocking post. Notice that the springs 1680 or 1580 need not do all work to put the device in place, and that external action may be used in the case of a post, and needs to be used in the case of a screw. In the case of a screw, as in the case of a post already discussed for that matter, a clamp will be used to prevent the spring from pulling when not desired, as well as to prevent accidental entering of a device in a hole. On FIGS. 4-C2, and 4-C3, 110x and 110y stand to designate arbitrary shapes of the main screw's head, as x or y can for instance take on values such as 0, 1, 2, etc. to represent shapes that we have already met previously (without attempting at listing all possible shapes): only the height of 110x and 110y makes there full sense as it is indicated in parts C2 and C3 of FIG. 4 how the blocking hole is placed correspondingly to that height in the vertical direction for essentially any main screw's head's shape.

Still on FIG. 4, but now in part D, the post is inside the blocking hole. The post could stay there by the effect of some cement used to close the top of the hole, and easy to remove, but we propose in D1 and D2 an alternate approach to keep the blocking post inside the blocking hole until one wants to remove it. To this effect, the ring of the post 1602 will remain easy to access (which does not mean that it has to stay above the level of the top of the hole as suggested in the figure). Then, with reference now to sub-part D1, a force 11675, lateral to the axis of the post, pushes out (e.g., by using the elasticity of an internal spring or just of the material being used) a small lateral protuberance 2690 that gets inside the cavity 1690 in the wall of the blocking hole, thus preventing the post from getting out from said blocking hole. This cavity can be either all around the hole which would be one preferred solution if the post and hole have basically round section (on the crestal side and apical side of the protuberance 2690), or only in one direction as suggested by the figure, while the figured solution would be more practical if the hole is not round and the post gets necessarily well positioned to get in. Next, with reference now to sub-part D2, a force 11671 in the direction inward to the axis of the post and thus opposed to 11675, is exerted laterally to the axis of the post, pulling in the protuberance 2690 and disengaging it from 1690 when a strong enough pull 1671 is exerted on the post, outward from the crestal end. As an example of the mechanisms involved, the pull 1671 can for instance be obtained by grabbing the post ring 1602 with a tool equipped with a hook of the appropriate size: once pulled outward from the crestal end, the ring will bring with it the end of the axis of the post and in turn the protuberance 1690 will be pulled inward the post, thus letting force 1671 get the post out of the blocking hole.

Remark: in the case the main screw has a head wider than its body, one can modify the systems described so far so that the part 1550 (for a blocking hole for a blocking screw) 1650 (for a blocking hole for a blocking post) is absent so that the blockage is relative. Because contact blocking is easily implemented in implantology, relative blocking is fine and there are obvious tradeoffs between using relative or absolute blockage with blocking screws or blocking posts.

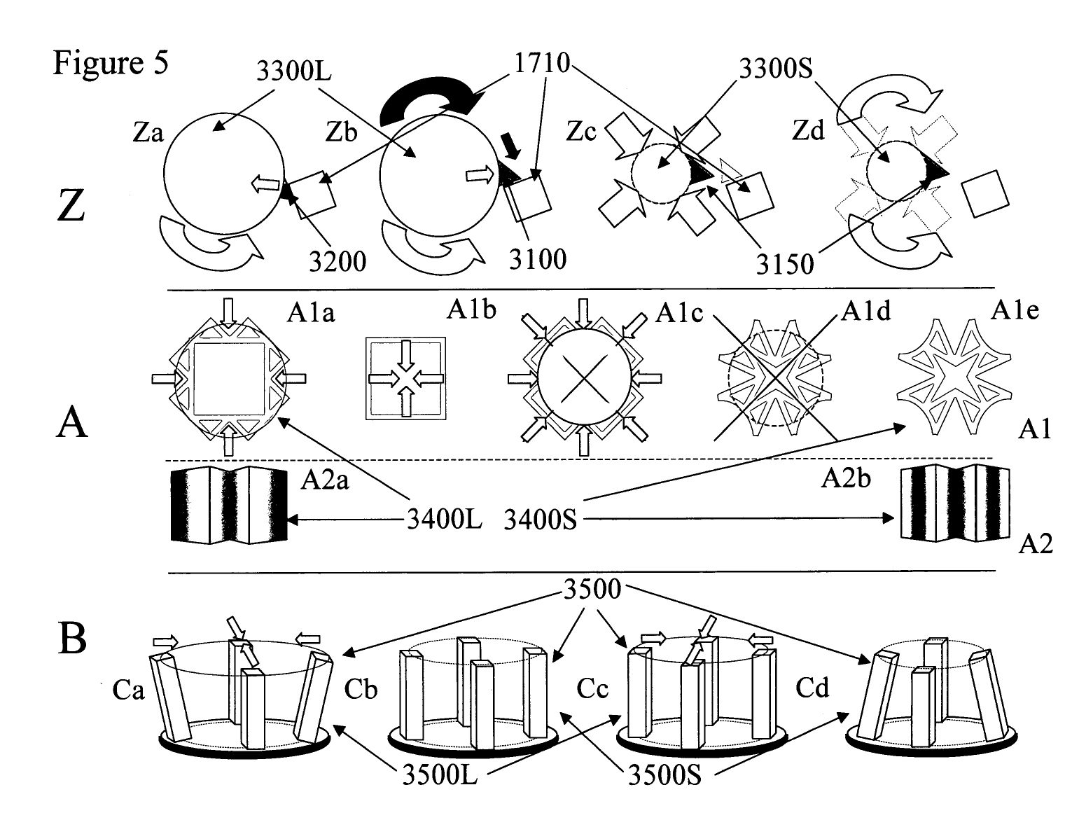

Coming now to FIGS. 5 to 11, the first comment is that we have there only implants of shape C, but this choice is arbitrary, and should not be understood as indicating any limitation on the applicability of the invention, and shape P would work as well, beside the fact that again, the methods of reversible stabilization of main screws illustrated by these figures would hold way beyond implantology or even overall prosthesis. As the first method that we have presented, the methods to be presented next cover various aspects of constructions such as building and all aspects of mechanics.

With reference now to FIG. 5 we see in part Z the schematic for a principle to build systems providing relative blockage that can also be used to build systems providing absolute blockage. In all of part Z, 1710 stands for posts that will be attached to the trans-screwed element for relative blockage, and that can sometimes extend to penetrate the support to provide absolute blockage. The principle goes as follows.

With reference first to subparts Za and Zb, one or more latches are attached to a transversally deformable support of diameter R to be attached to the head of the main screw. Said support is represented in sub-parts Za and Zb by the disc 3300L. The latches can pass the post 1710 if turned in the screwing direction (said direction being represented by the grey curved arrow), as at 3200, where passing the post creates the force represented by the inward pointing straight small grey arrow. In the unscrewing direction (said direction being represented by the black curved arrow), we see in sub-part Zb that the latch is blocked at 3100 (in the sense of trying to exert the force represented by the straight small black arrow tangential to the circle that bounds the disc 3300L). With reference now to subparts Zc and Zd, we first see in Zc the four grey arrows that represent an inward force exerted on the support so that it gets inside the smaller disc 3300S with radius r<R. In fact said radius r is intended to be small enough for the latch or latches attached to the support to not interact any more with post 1710. In the background of sub-part Zc, one sees the disc-latch ensemble before deformation to get a clearer view of the contraction transforming 3300L into 3300S. With reference then to sub-part Zd, one sees that with the smaller radius r, the two directions of rotation (represented by the two white curved arrows) the disc-latch ensemble deformed by the inward force can turn in both direction so that one can both screw or unscrew as needed,

The principle presented in part Z of FIG. 5 can easily be recognized as providing the locking properties that are claimed, while providing means for the possibility to dismount: it remains to exhibit shapes or principles for the support that have the properties illustrated in part Z. This is done in parts A and B in a quite general context, and we will come to concrete implementations on the basis of these parts of FIG. 5 in subsequent figures.

With reference still to FIG. 5 we see in part A an exemplary system shown from the top in the top line A1, and from the side in line A2. Said system has a cross-shaped section, possibly with a square attache to the cross as indicated in sub-part A1a, but the square may be abstract and not be effectively part of the system. The latches come out of the branches of the cross. Starting from the radius R configuration seen from above in sub-part A1a, and from above in sub-part A2a, one exerts inward forces along the grey inward arrows of A1a on the inner angles of the cross. The way this acts on the square (that is attached to the cross or that is just an abstraction) is represented in A1b. The deformation under the inward forces of the actual or abstract square is shown in sub-part A1c, where the white arrows show the secondary inward forces that are exerted on the arms of the cross because of the primary push represented by the grey arrows in A1a: the grey disc masks further details as only an induction of forces needs to be illustrated at this point. More precisely the inducing of forces on the arms from forces exerted on the inner angles of the cross as in A1a, or on the side of the square as in A1b. The effect of said secondary forces on the arms of the cross is represented in sub-part A1d, where one sees that the support of the latches has come into a disc of diameter smaller than the diameter circle needed before inner forces were exerted. The final shape under inward compression, but cleaned from the circle and axes that were there to help understand the geometry of the system, is represented in sub-part A1e for the top view, and A2b for the side view, To summarize, the cross before compression at 3400L is inscribed in a circle with radius R larger than the radius r of the circle in which the compressed cross at 3400S is inscribed: so part A gives a first instantiation of the principle of part Z. With reference still to FIG. 5 we see in part B, we see alternate instantiations of the principle of part Z, using now pillars. The pillars (here four of them but the number can as well be smaller or bigger) are the supports of the latches. The position without inward force is 3500L with radius R pointing outward in sub-part Ca, and straight in sub-part Cc: the forces on these rest shapes before they get deformed is figured by the small inward pointing grey arrows. Under these inward forces, one gets to positions 3500S with radius r<R in sub-parts Cb with vertical pillars, and Cd with inward pillars. Other configurations could be used: for instance inward pointing pillars both with and without forces, but with different radiuses for the circles in which the latches supporting part are included when the inward forces are exerted or not: obvious other combinations would work as well.

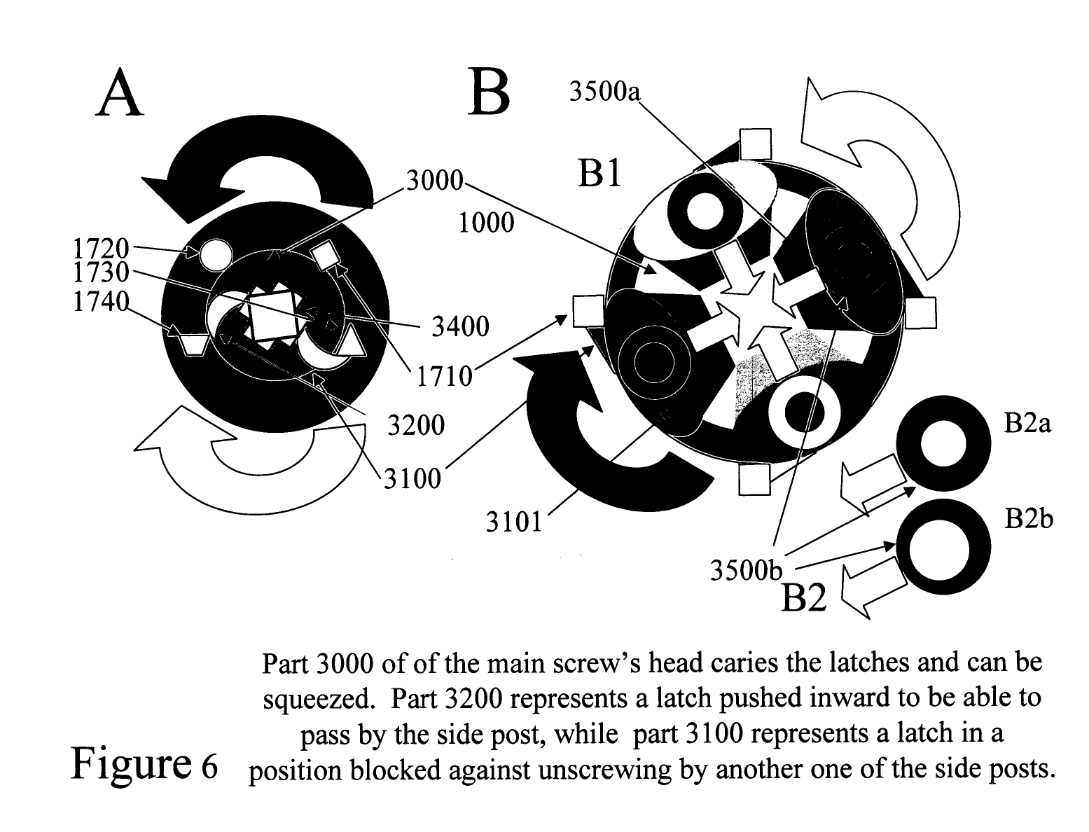

With reference now to FIG. 6 we see respectively in parts A and B, the system from parts A and B of FIG. 5, with now the latches attached to the flexible system and attachment of that system to the top of the head of a screw. The curved arrows represent in grey the screwing direction and in black the unscrewing direction, both in parts A and B. In part A, we see at 3100 and 3200 latches that are attached to the head of the main screw, and in fact elastically attached using the system from part A of FIG. 5. At 1710, 1720, 1730, and 1740, we see examples (and only one kind need to be used at a time) of side posts that are used to both:
Push the latches inward along the radius when they pass by the side posts in the screwing direction, and
Block the latches in the unscrewing direction,
   so that 3200 indeed represents a latch pushed inward to be able to pass by the side post 1740, while 3100 represents a latch in a position blocked against unscrewing by another one of the side posts at 1730.

In part A of FIG. 6, the portion 3000 of the head of the main screw caries the flexible system 3400 (from part A of FIG. 5) that holds the latches and that will be squeezed (possibly with an easily designed special clamp) to bring inward the latches so hat they do not prevent unscrewing when one needs to unscrew. At 3400, we show an example of a hollow cross-shaped top of the head supporting some latches-as was presented in part A of FIG. 5. By squeezing the cross at its inward external angles and pushing inward along the radius as described in the discussion of part A of FIG. 5, one brings the latches out of the blocked position; this allows one to unscrew at will, according to the principles of part Z of FIG. 5. A screwdriver can penetrate the hollowed part in the center of the cross to help in screwing or unscrewing, in which case squeezing the outside of the cross is mainly used to keep the latches closer to the axis of the main screw. Otherwise, an easily designed squeezing toll can be used as well for the screwing and unscrewing functions.

With reference now to part B of FIG. 6, another system (absolute or relative depending as well on where the posts are attached) is presented, where the elasticity and grip is shared between the latches at 3100 and the top 3101 of the pillars 3500 onto which the latches are fixed on the crestal face: this system is nothing but an instantiation of the pillar implementation of part Z of FIG. 5 that was presented schematically presented as part B of FIG. 5. By grabbing the pillars 3500, and pushing inward to pull them in, one gets that the latches 3100 are pulled inward along the radius for unscrewing and easier screwing. The grabbing is done using superstructure 3500b of the pillars. Sub-parts B1 represents the top view of said pillar-based system, with the superstructure 3500b that will serve to grab the pillars magnified in sub-part B2. There, B2a shows a view from above, and B2b shows a section parallel to the plane tangent to the top part, at a level that lays somewhat below the top: the difference in shapes at B2a and B2b allows a secure grip one the pillars when one wants to pull the latches inside, using any of easily designed special tools. In sub-parts B1 and B2, the fat grey arrows indicate the axes along which the inward pulls (on the pillars and hereby on the latches that they carry) are performed.

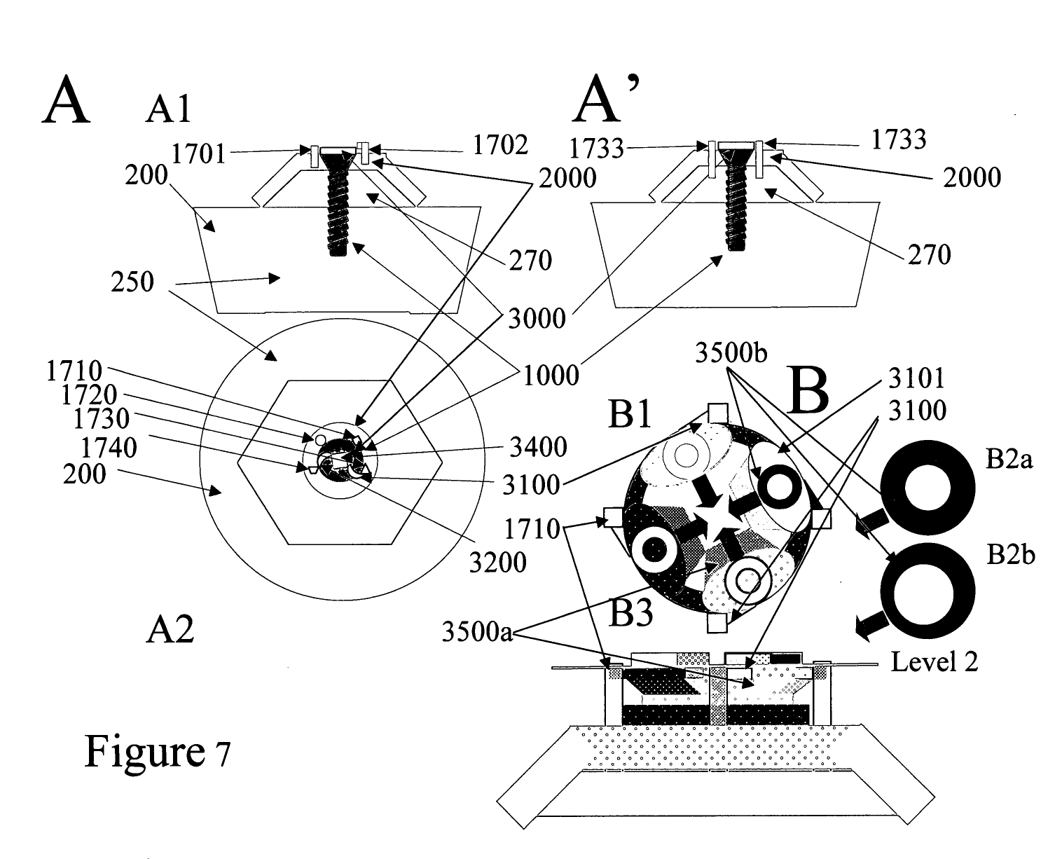

With reference now to FIG. 7 we see in part A, a system of relative blockage, adapted in A′ to become a system of absolute blockage: the system is in fact the one from part A of FIG. 6, now represented in the context of implantology, and with details on the side view.

In sub-part A2 (which contains at its center what was represented in FIG. 6A) we see again at 3100 and 3200 latches that are elastically attached to the head of the main screw. At 1710, 1720, 1730, and 1740, we see (as in FIG. 6) different examples of side posts (and only one kind needs to be used at a time, but we have put several shapes together to avoid the multiplication of the number of figures) that are used to both:
Push the latches inward along the radius when they pass by the side posts in the screwing direction, and
Block the latches in the unscrewing direction,
   so that 3200 indeed represents a latch pushed inward to be able to pass by the side post, while 3100 represents a latch in a position blocked against unscrewing by another one of the side posts.

The vertical shape of the side posts can also vary, with two examples figured in part A1 with labels 1701 and 1702. The side posts can also traverse the trans-screwed element and be attached to the support as represented with label 1733 in part A′, in which case the blockage is absolute.

With reference now to part B, another system, absolute or relative depending as well on where the posts are attached (they are figured long enough for absolute blockage, but the relative version is easily deduced from what is presented) is presented, where, as was told, the elasticity and grip is shared between the latches at 3100 and the top 3101 of the pillars onto which the latches are fixed on the crestal face. Again, like for part A, the core system is an instantiation of the corresponding part from the previous Figure. By grabbing the posts inward at 3500b and pulling them in the latches are thus pulled inward along the radius for unscrewing and easier screwing. Sub-parts B1 and B3 represent corresponding top and side view of variation B of the version B of the principle in part Z of FIG. 5 (with elements in C1 corresponding in obvious way to elements under them in view C2), with the superstructure 3201 magnified in sub-part B2 (like in FIG. 6), where B2a shows a view from above, and B2b shows a section at the Level 2 represented by an horizontal line in subpart B3. As already explained when discussing FIG. 6, the difference in shapes at B2a and B2b allows a secure grip when one wants to pull the latches inside, using any of easily designed special tools. In sub-parts B1 and B2, the fat arrows indicate the axes along which the pulls on the latches are performed.

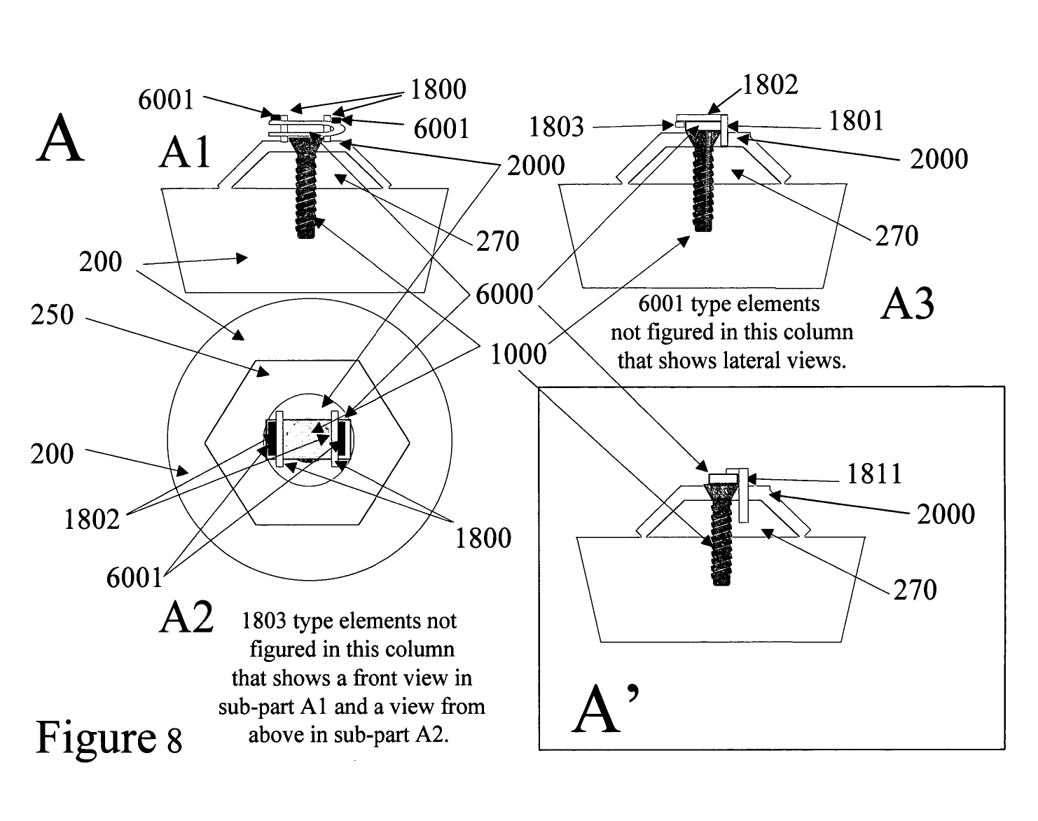

With reference now to FIG. 8 we present, in part A, a second mean to ensure relative blockage, with an associated absolute version in B, but since the posts being used now have a shape forming sort of a portal, not all posts shapes that can accommodate a relative blockage can be used for absolute blockage. The strip with vertical elasticity at 6000 gets blocked by the two posts at 1800. Each post 1800 is made up of three parts: a vertical pillar 1801, a horizontal bar 1802, and a small protrusion 1803. Horizontal bar 1802 can go over the full width of 6000, at least in the relative case, as we have shown in sub-part A2 from above and in the side view in sup-part A3. Said vertical elasticity (by which is meant according to the conventions we have used an elasticity along the direction parallel to the axis of the main screw) once 6000 is in place, may be generated or improved by using a doubly-shitted shape as shown in FIG. 8, or more generally a multi-shitted shape, but this is only an example to get the desired elasticity, and should not be understood as a limitation on the means to achieve such vertical elasticity. We see also in sub-part A3, at 1803, a preferred detail in the shape of a downward protrusion terminating the horizontal arms 1802 of the posts 1800, which allows blocking the strip 6000 from sliding to the front of the posts (sliding in the opposite direction is prevented by the vertical abutments parts 1803 of the posts that are shown in sub-part A3 of FIG. 8). On the lateral view of sub-part A1, we see at 6001 other facultative but preferred attached details that are now protrusions attached to (or are part of) the strip 6000: the role of said protrusions 6001 is to prevent the strip 6000 from sliding left or right thanks to the horizontal arms 1802 of the posts 1800.

As a consequence, with all the attached or included details (to the posts at 1803 and to the strip at 6001), all directions of sliding are prevented and one gets a stabilization of the main screw held in place by the strip 6000, itself prevented from accidentally go off. The reversibility of this stabilization and the means to put it in place are provided by using the elastic properties previously required of part 6000; more precisely, at the cost of using an easily designed special tool. One can squeeze vertically the strip 6000 to force it in and out of position under the portal formed by the posts: the clamp will also serve to secure the piece 6000 during the maneuvers of mounting or dismounting, and avoid loosing 6000 in the mouth of the patient in the context of oral surgery.

All subparts A1, A2, and A3 should be considered together to get a good understanding of the preferred embodiments for strip 6000 and the way it relates to posts 1800 in order to provide all that is needed for reversible stabilization of main screw 1000. For instance, the protrusions 1803 of the posts 1800 have not been represented in the left column of drawings in FIG. 6 to avoid obscuring the other detail that need to be presented there, or because they would have come in front or behind other elements that need to be presented. Similarly, the protrusions 6001 of the strip 6000 have not been represented in the right column of drawings in FIG. 8 to avoid obscuring the other detail that need to be presented there, such as the view on post 1801 for the relative case in sub-part A3, and of the post 1811 that would replace post 1801 in the absolute case in sub-part A′, where as in FIG. 7-A′, the absolute character of the blockage is due to the fact that the posts go though the trans-fixed element and are attached to the support. We have also represented at 1811 the fact that the posts hardly can advance as much in the absolute case as in the relative case, which is thus preferred for the overall matter discussed on the basis of FIG. 8.

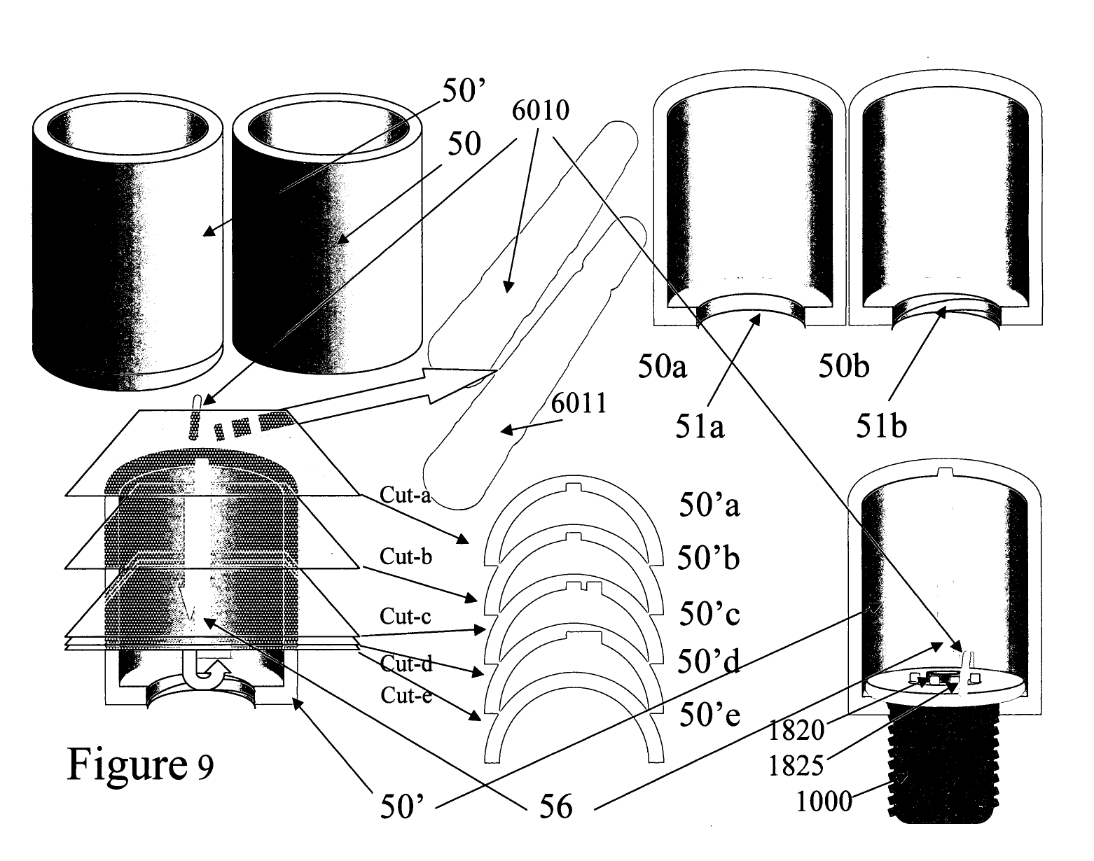

With reference now to FIG. 9, we see at 50 and 50′ two sorts of shapes for an abutment (with no intent of limitation), where 50 is more often used and will be the case considered further. The median vertical cuts of 50 are represented as 50a and 50b, depending on whether the bottom hole is not threaded as shown at 51a, or threaded as at 51b: 50b is far less frequent but will nevertheless be used in the sequel, with no intent of limitation as 50a could be used as well. A 50a model is used to build a very specific implementation of the concepts that underline the solution proposed in the comment of FIG. 8, where an elastic device (strip, rod, or else: here we will use rod, which should not be interpreted as implying any limitation) is blocked by some trap so as to keep the main screw captive. Instead of posts as 1800 in FIG. 8, the elastic rod will now blocked by especially shaped gutters carved in the walls of the abutment. The fact that the traps for the elastic rod are carved in the vertical walls of the abutment essentially limits the blockage to be only relative (which is mostly immaterial as contact blocking is easy and natural in oral implantology). Two gutters that are symmetrical of each other or about so, one of which only appears in our illustrations, will be used to trap one elastic rod,

To understand the shape of the gutters, five horizontal cuts, by planes Cut-a to Cut-e, are provided, and; marked 50′a to 50′e. In particular, comparing the holes that are so revealed in the walls of the modified abutment, and the side views of said modified abutment 50′, one sees that the gutter has a lower hook that terminates in the right hole shown in 50′c. This is where the rod 6010 gets inserted using its elasticity. The rod is also shown in two magnified shapes: it can in fact be used as a separate piece of equipment, for which the straight version 6010 would work, but one may prefer a more complicated shape as indicated at 6001, and more generally a shape that allows the rod to stay captive on one end of one of the gutters, the second end being used only after the screwing is secured. We show indeed a rod in blocking position above screw 1000. Notice that a system to screw and unscrew at 1820 and other protuberances 1825 have been figured that may be used to better block the rod 6010, in the spirit of what was presented in the discussion of FIG. 8: this would block rotation of the screw, but this is not in dispensable as the blocking by the rod would prevent vertical displacement of the main screw anyway.

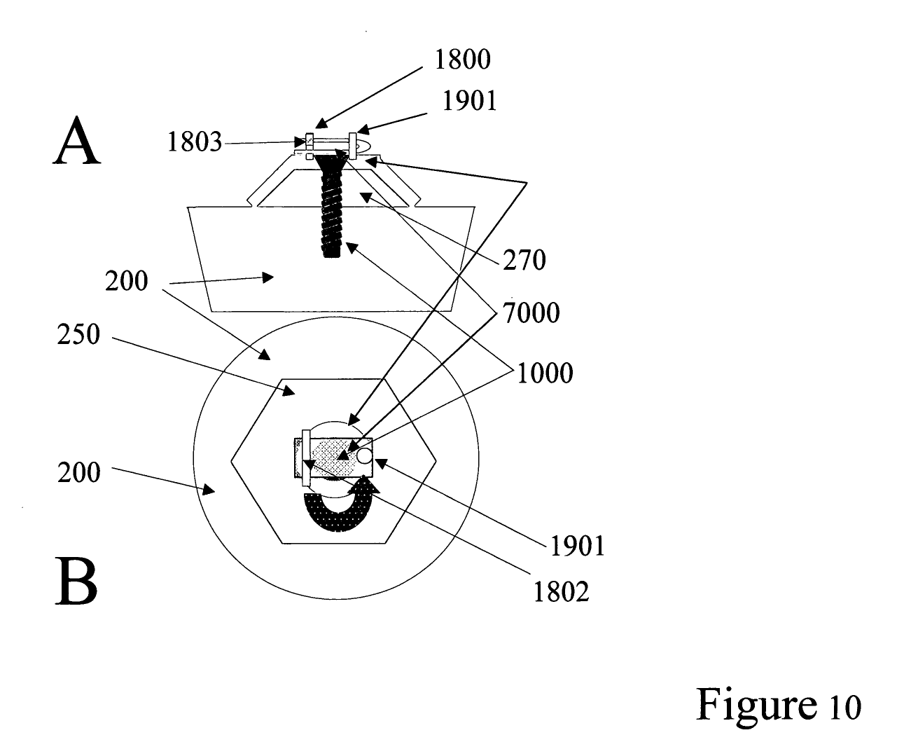

With reference now to FIG. 10, we present a third manner to provide relative blockage, somewhat adapted from the relative case in FIG. 6: now the strip 7000, still preferably endowed with vertical elasticity, turns as we have figure in sub-part B with a round arrow, around the pivot 1901, and gets blocked under horizontal arm 1802 of the post 1800. One may prefer to have the pivoting of the strip getting into the blocking position in the screwing direction or opposite to it. Protrusion 180 of the post 1800 plays the same stabilization role as discussed before in previous manner to provide blockage illustrated in FIG. 8, but now no other protrusion is needed as side slippage is prevented by the attachment of strip 7000 to pivot 1901.

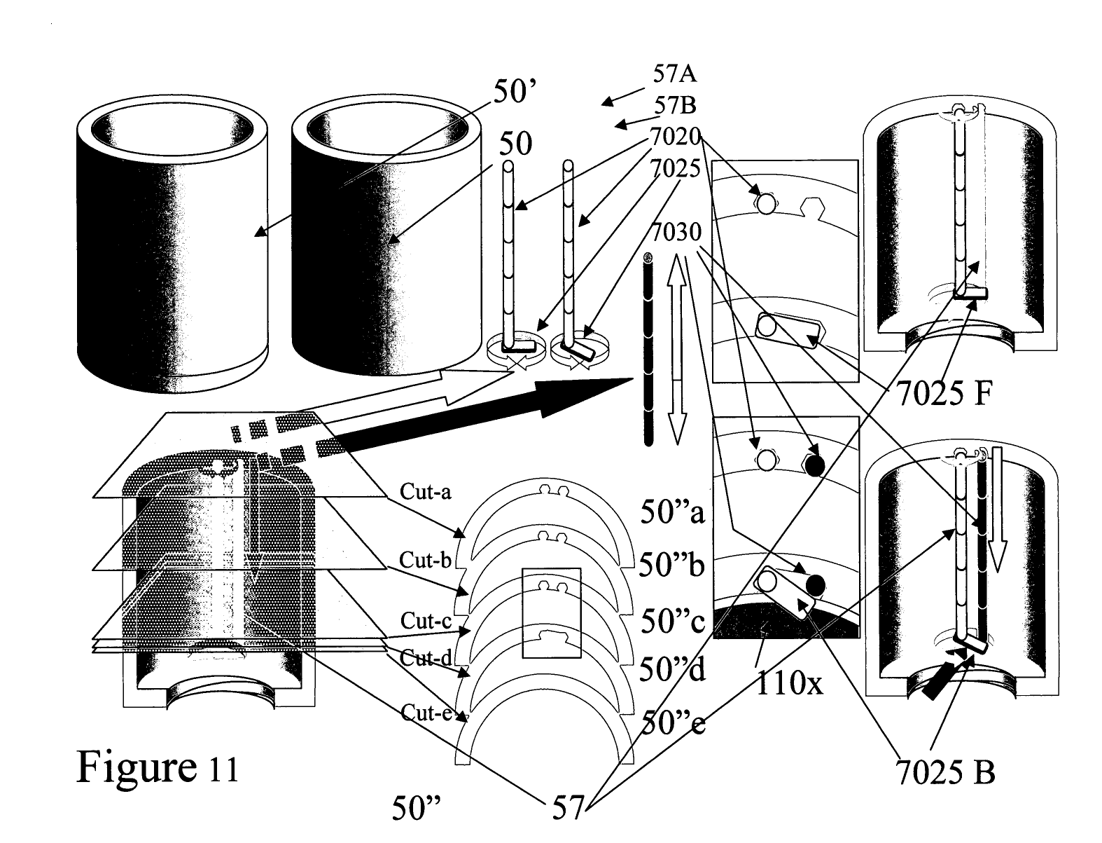

With reference now to FIGS. 11, we show a precise adaptation to the geometry of the abutment of what was discussed in the comments of FIG. 10, parallel to how the system in FIG. 8 lead to the adaptation in FIG. 9. Thus in FIG. 9, we see at 50 and 50′ the two sorts of shape for an abutment that were shown in FIG. 9 (again with no intent on limitation), where 50 is more often used and will be the case considered further. The median vertical cuts of 50 that was represented as 50b in FIG. 9, and which has a bottom hole that is threaded, will be used for further illustration in FIG. 11: as we already mentioned, 50b is far less frequent but will nevertheless be used in the sequel for definiteness, but with absolutely no intent of limitation as 50a could be used as well. A 50 model is used to build a very specific implementation of the concepts that underline the solution proposed in the comment of FIG. 10, as will be explained next. The
a) Rotation axis 1901,
b) Blocking post 1801,
c) And strip 7000 from FIG. 10
   will now be replaced by:
a) Rotation axis 7020,
b) A (possibly but not preferably removable) blocking post 7030:

blocking post 7030 and rotation 7020 are homed close and in parallel to each other, in pairs of gutters that occupy one or more vertical strips on the wall of the abutment (only one said pair has been figured here, and one pair is enough, while two or three would be optimal),
c) And a pad 7025 attached to end of 7020 that is the piece that will effectively block the main screw as we explain next.

Using this implementation of the basic concepts behind the discussion of FIG. 10, we get that if one turns 7020 (from the free position 7025F to the blocking position 7025B) once the screw is in place, Pad 7025 blocks the top of the screw head 110x (where x stands as before for 0, 2, 3, to indicate that several shapes of main screw heads would work) as figured in the magnification of the rectangles in the views 50″a to 50″e of cuts Cut-a to Cut-e that parallel the logic of presentation used in FIG. 9. The blocking rod 7030 goes up or down and can be altogether absent from the system before it is used for blocking. The blocking function of blocking rod 7030 is on the pad 7025 as shown in the two representations of the blocking configuration 7025F. The rod 7030 can also be embedded in the system and just kept high enough for the pad 7025 to be in the 7025F position until the pad 7025 needs to stably be in position 7025B to block the main screw, at which time the blocking rod in brought into play as shown to prevent the pad from folding back into the 7025F position.

With reference now to FIGS. 12, 13, 14, and 15, we revisit details associated to the sub-case of the first method when the blocking hole occupies part of the main screw, which is thus hollow to accommodate a part of the blocking hole. Only the case when the blocking device is a screw is presented here with more details, as adaptations to a blocking post would easily be deduced.

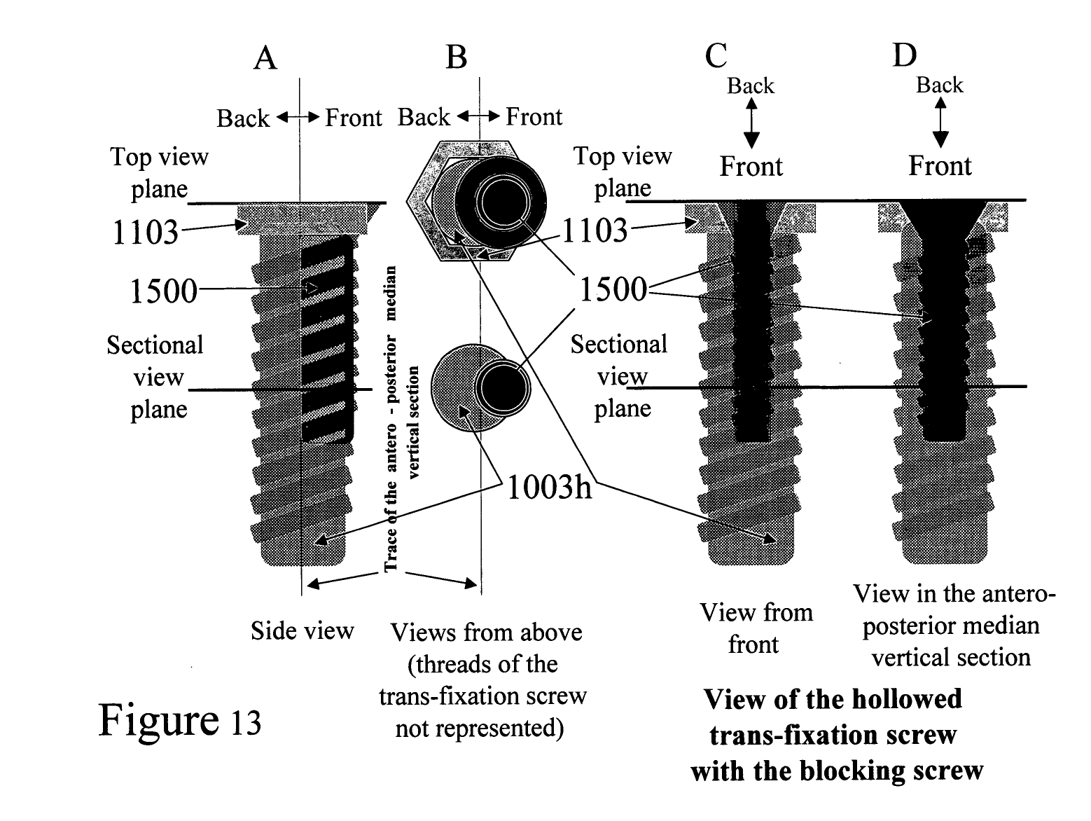

With reference now to FIG. 12, 1003h represents a screw with geometry 1003, but in the case when it is hollow so that it can contain part 1551 of the blocking hole, which will possibly be threaded (threads are presented in the figures, but are not mandatory and in fact may be better avoided in some cases as discussed below). Shown on the left in part A is the screw seen from the side (a latero-lateral view) with the hollow part to the extreme right, which is what we call the front of the screw, which front is indicated in opposition with the back in parts A to C of both FIGS. 12 and 13. The two rightmost pictures in parts C and D are as indicated a view from the front of the antero-posterior positioning of the screw in C and to the extreme right in D, a view from the same point of view, but in the antero-posterior median plan. The position of that median antero-posterior plan is also indicated by a vertical line in parts A and B, where part B complements the side views from parts A, C, and D, by transversal views, and more precisely a top view at the top of the column that constitutes part B, and a sectional view at the level marked as sectional view plane by horizontal lines in parts A, C, and D.

With reference now to FIG. 13, views exactly similar to those in FIG. 12 are presented there, but now with the trans-fixation-screw 1500 in place, filling the hollow part 1551 from FIG. 12. A blocking post could have been illustrated almost similarly and with obvious modifications to what has been represented in FIGS. 12 and 13, which should be understood as refereeing to any blocking device.

The columns B in FIGS. 12 and 13 assumed that the holes in the main screw and surrounding medium could be exactly aligned or so-nearly that in particular when the blocking device is a screw, no interaction with the threading would need to be seriously considered. While such perfect or nearly perfect correspondence may be achieved in some cases, this might not always be the case. One can easily be convinced that only one of the main screw and the support needs then to have an enlarged hole to have a good match. Said good match is then:
Option1: Either between a part of the hole of the exact needed size for the device on the main screw and a properly shaped enlarged hole on the support.
Option2: Or between a part of the hole of the exact needed size for the device on the support and a properly shaped enlarged hole on the main screw.

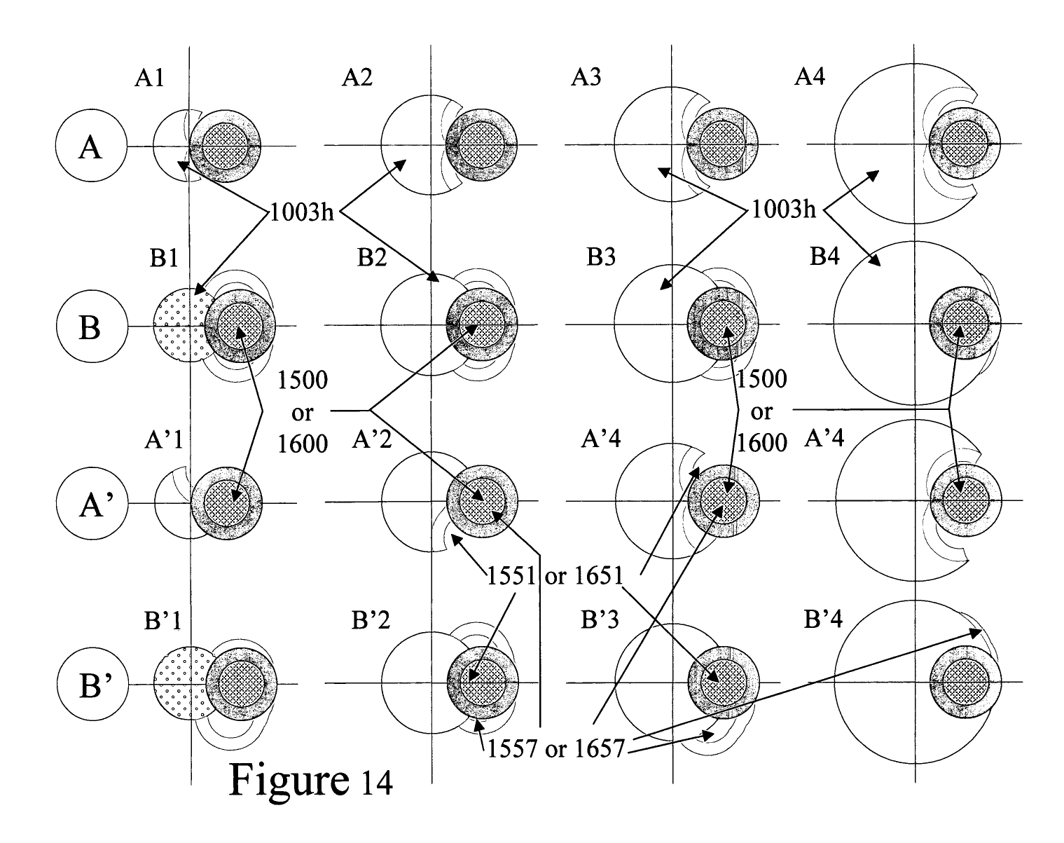

With reference now to FIG. 14, these two options are represented respectively as lines A and A′ for enlarged holes in the main screw and as lines B and B′ for enlarged holes in the support (with the unprimed lines corresponding, both in the case of A and B, to the match coming just in the middle of the enlarged holes). The outer parts of the holes, which are everywhere shaded, is where threading could be placed if the device would be a screw, or otherwise speaking, indicate the width of the threading of the blocking screw if the device is a screw. But comparing for instance A1 and A′1, or B3 and B′3, or for that matter any such pair (Xn, X′n) where X stands for A or B and n is one of 1,2,3, and 4, one sees that the precise positioning of the screw on the size where it is fixed determines what is the shape of the threading on the other side along the horizontal axis in any of the 16 sub-parts of FIG. 14. A change in adjustment would impose the same state of threading all over in the enlarged hole. However, this is incompatible with the basic helicoidal nature of threading, so that no threading will equip the enlarged hole when a perfect mach is not possible, is the preferred solution, even if the blocking device is a blocking screw. The same numbers used in previous illustrations mark in FIG. 14 the same parts as before on some of the 16 sub-parts, this is done to better understand the teaching of this picture where different relative sizes of the main screw and blocking devices have been considered, both in the cases A, A′ and B, B′. The sizes of the enlarged holes have been taken rather large for better visibility, and one would expect that in most case the enlarged hole be only a few percents larger than a perfect matching hole. In the case perfect matching is indeed expected, and no enlarged hole is needed, threading will often be preferred in both parts of the chamber when the device is a screw.

Instead or besides approximated fitting handling as has just been discussed, one can also make fitted screws by using trials and measurements to make sure that preset positions of the blocking devices are compatible with appropriate strength of securing the screws. Anyway, there are usually margins of acceptable blocking strength which will often be enough to make sure that one can get good matches and make the discussion of approximate fitting irrelevant or mostly irrelevant.

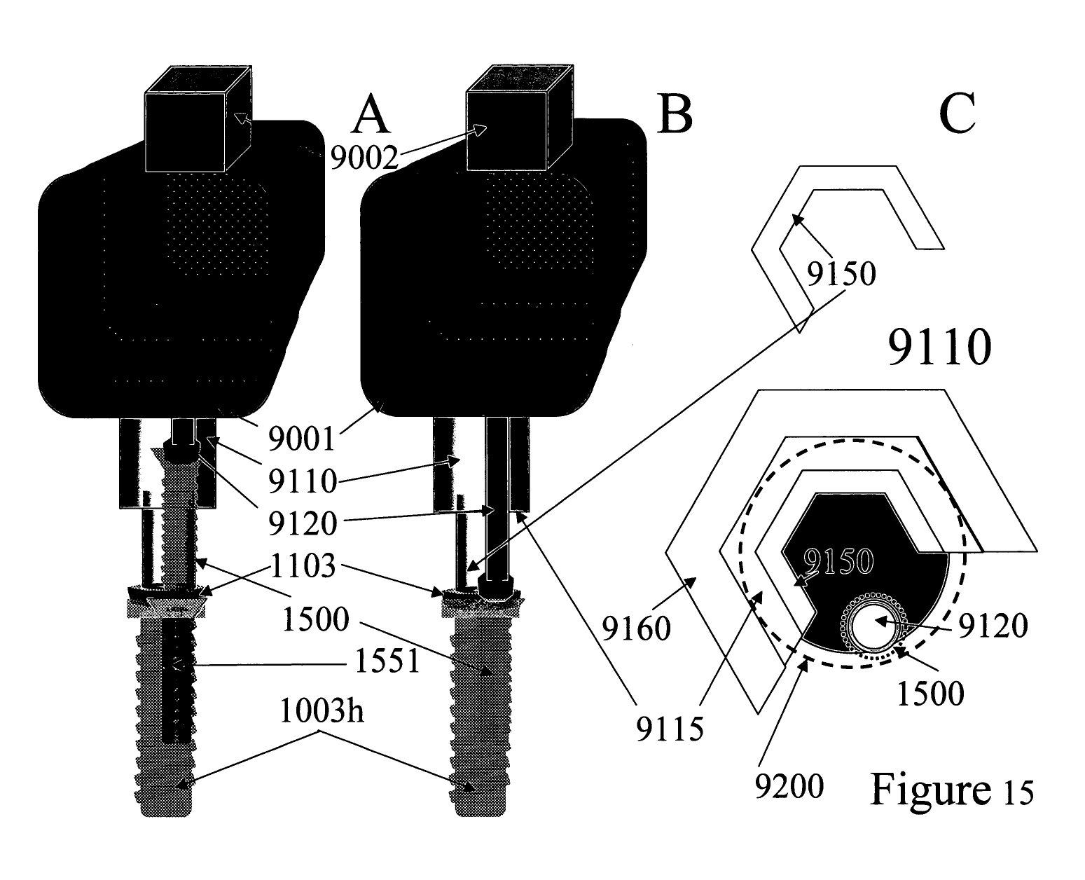

As the sizes involved in dentistry and other surgical specialties are rather small, handling both the main screw and the blocking screw close to each other could be tricky without the recourse to special instruments. With reference now to FIG. 15, we see here such an instrument with the same screw driving engine at 9001 holding the two screwdrivers, 9110 is a branch holding the main screw, and 9120 is a branch used for the blocking screw. The engine 9001 may have to have a shape accommodating retraction of branch 9120, as represented as 9002. The engine will be held in some appropriate way one which we do not need to indicate any limitation nor hint for possibility so that such holding part has not been represented at all.

As before 1003h represents a screw with head 1103 and hollowed, taken as an example with no intent of limitation. 1551 is the hollow part of 1003h that hosts part of the chamber for the blocking screw 1500, which is held up in part A while 1003h is put in place by arm 9110. Arm 9110 is holding 1003h and rotating around arm 9120 to screw (or unscrew) 1003h. Then arm 9110, which has revolved around 9120 and is shaped as indicated in part C, next holds 1003h while 1500 is screwed by the screwdriver 9120 (whose section is mostly arbitrary, as long as adapted to the head of 1500 (a nut fitting in a hexagon would be a good choice)) as shown in part B which represents the situation once all is in place and 1003h is stabilized by 1500. If unscrewing is needed, the same apparatus can be used in an obvious manner, since one just has to unscrew in the reverse order of the order used at time of screwing.

One can see in the side views in parts A and B, complemented by part C the shape of arm 9110. Its bottom part has an outside shape 9150 that will be the piece forcing the rotation or stabilization of 1003h as needed (the head of 1003h has of course to have a shape adapted to the section 9150 of the bottom of 9110 for 9110 to act properly on 1003h). For the rotation of 9110 to happen around both arm 9120, and auxiliary screw with screw head 1500, it suffices that the upper part of arm 9110 stays out of the circle 9200 presented in dashed line in part C: this will be realized by the arm 9110 getting wider and wider, with a joint 9115 (here horizontal but this horizontality is not necessary) that gets from the lower profile 9150 to the wider upper profile 9160 that remains out of circle 9200.

Small and anyway obvious modification would allow to transform the tool depicted here into a tool for the system with a blocking post instead of a blocking screw.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof and that changes may be made therein which still fall within the spirit and scope of the invention. Thus, it is intended that the scope of the present invention herein disclosed should not be limited by the particular disclosed embodiments described above, but should be determined by the appended claims.

1. A system to block screws, without access to the side nor back, which allows to protect against accidental unscrewing but performs its blocking function in a reversible way in that it allows unscrewing without breaking any part when needed.

2. The system of claim 1, using one or more blocking devices, whether said devices are blocking screws or blocking posts or a combination thereof, whose axis is parallel to the axis of the screw to be blocked in a reversible way.

3. The system of claim 2 where a clamp holds any of the blocking devices so that it engages into its appropriate blocking hole at its appropriate time.

4. The system of claim 2 where a spring helps the blocking device to get in he appropriate blocking hole at the appropriate time.

5. A system of reversible blocking of screws as recited in claim 1, using a strip or rod which gets trapped under appropriately shaped traps placed near the screw to be blocked, so that said strip prevents said screw from any motion in the direction of unscrewing once it is in place, but said strip can be taken out if unscrewing id needed.

6. A system of reversible blocking of screws as recited in claim 5, using any of a strip or rod with elasticity in the direction of the axis of the screw to be blocked, and such that getting the strip in place and out is done using said elasticity of said strip.

7. The system of claim 5 where protrusions of said post and protrusions of said strip prevent any accidental slipping of said strip out of place in any direction.

8. A system to block screws as recited in claim 1, using a strip or pad that turns around a pivot so that said strip or pad gets blocked using another mobile or immobile part above the head of said screw, thus preventing the screw from getting accidentally unscrewed, but so that the strip or pad can be put back in non-blocking position, thus allowing unscrewing of said screw at will.

9. The system of claim 8 where said strip or rod has vertical elasticity that can be used to put it in place and out of blocking position when needed and a protrusion of a said post prevents the strip from getting accidentally out of place.

10. The system as recited in claim 5, when blockage is relative.

11. The system as recited in claim 6, when blockage is relative.

12. The system as recited in claim 7, when blockage is relative.

13. The system as recited in claim 8, when blockage is relative.

14. The system as recited in claim 9, when blockage is relative.

15. The system as recited in claim 5, when blockage is absolute.

16. The system as recited in claim 6, when blockage is absolute.

17. The system as recited in claim 7, when blockage is absolute.

18. The system as recited in claim 8, when blockage is absolute.

19. The system as recited in claim 9, when blockage is absolute.

20. A system to block screws as recited in claim 1, using latches attached to the head of the screw to be blocked, said latches preventing said screw from getting accidentally unscrewed by getting blocked by side posts, and said latches being brought back along the radius toward the axis of said screw to permit unscrewing when needed.

21. A system as recited in claim 1, adapted to reversibly stabilizing the trans-screwing of a prosthetic abutment on the crestal end of a dental implant.

22. A system as recited in claim 2, adapted to reversibly stabilizing the trans-screwing of a prosthetic abutment on the crestal end of a dental implant.

23. A system as recited in claim 3, adapted to reversibly stabilizing the trans-screwing of a prosthetic abutment on the crestal end of a dental implant.

24. A system as recited in claim 4, adapted to reversibly stabilizing the trans-screwing of a prosthetic abutment on the crestal end of a dental implant.

25. A system as recited in claim 5, adapted to reversibly stabilizing the trans-screwing of a prosthetic abutment on the crestal end of a dental implant.

26. A system as recited in claim 6, adapted to reversibly stabilizing the trans-screwing of a prosthetic abutment on the crestal end of a dental implant.

27. A system as recited in claim 7, adapted to reversibly stabilizing the trans-screwing of a prosthetic abutment on the crestal end of a dental implant.

28. A system as recited in claim 8, adapted to reversibly stabilizing the trans-screwing of a prosthetic abutment on the crestal end of a dental implant.

29. A system as recited in claim 9, adapted to reversibly stabilizing the trans-screwing of a prosthetic abutment on the crestal end of a dental implant.

30. A system as recited in claim 10, adapted to reversibly stabilizing the trans-screwing of a prosthetic abutment on the crestal end of a dental implant.

31. A system as recited in claim 11, adapted to reversibly stabilizing the trans-screwing of a prosthetic abutment on the crestal end of a dental implant.

32. A system as recited in claim 12, adapted to reversibly stabilizing the trans-screwing of a prosthetic abutment on the crestal end of a dental implant.

33. A system as recited in claim 13, adapted to reversibly stabilizing the trans-screwing of a prosthetic abutment on the crestal end of a dental implant.

34. A system as recited in claim 14, adapted to reversibly stabilizing the trans-screwing of a prosthetic abutment on the crestal end of a dental implant.

35. A system as recited in claim 15, adapted to reversibly stabilizing the trans-screwing of a prosthetic abutment on the crestal end of a dental implant.

36. A system as recited in claim 16, adapted to reversibly stabilizing the trans-screwing of a prosthetic abutment on the crestal end of a dental implant.

37. A system as recited in claim 17, adapted to reversibly stabilizing the trans-screwing of a prosthetic abutment on the crestal end of a dental implant.

38. A system as recited in claim 18, adapted to reversibly stabilizing the trans-screwing of a prosthetic abutment on the crestal end of a dental implant.

39. A system as recited in claim 19, adapted to reversibly stabilizing the trans-screwing of a prosthetic abutment on the crestal end of a dental implant.

40. A system as recited in claim 20, adapted to reversibly stabilizing the trans-screwing of a prosthetic abutment on the crestal end of a dental implant.

41. A system as recited in claim 2, when the blocking devices traverse the head of screw to be blocked but stay clear from the body of said screw to be blocked.

42. A system as recited in claim 2, when some blocking device that traverses the head of screw to be blocked, enters a hollowness in the body of said screw to be blocked.

43. A system as in claim 41, when some said blocking device that is a blocking screw gets screwed in the direction opposite of the direction in which said screw to be blocked gets screwed.

44. A system as in claim 42 where the match of the parts of the blocking holes in the screw to be blocked and in the support cannot be expected to be exactly matched.

45. An apparatus to use a screw to be blocked and helps perform blockage of that screw as in claim 41.

46. An apparatus to use a screw to be blocked and helps perform blockage of that screw as in claim 42.

47. An apparatus to use a screw to be blocked and helps perform blockage of that screw as in claim 43.

48. A system as recited in claim 41, adapted to reversibly stabilizing the trans-screwing of a prosthetic abutment on the crestal end of a dental implant.

49. A system as recited in claim 42, adapted to reversibly stabilizing the trans-screwing of a prosthetic abutment on the crestal end of a dental implant.

50. A system as recited in claim 43, adapted to reversibly stabilizing the trans-screwing of a prosthetic abutment on the crestal end of a dental implant.

51. A system as recited in claim 6, where said elasticity of said strip is obtained or improved by using a multi-shitted strip.

52. A system as recited in claim 5, where said trap is a post.

53. A system as recited in claim 5, where said trap uses gutters in the walls of the piece that needs to be trans-screwed.

54. A system as recited in claim 53, where what need to be secured is an abutment for dental prosthesis and the trap is managed in the walls of the abutment.

55. A system as recited in claim 8, where said trap is a post.

56. A system as recited in claim 8, where said pivot of the pad and part blocking said moving pad are hosted in gutters in the wall of the piece that needs to be trans-screwed.

57. A system as recited in claim 56, where what needs to be secured is an abutment for dental prosthesis and the trap is managed in the walls of the abutment.

58. A method to block screws, without access to the side nor back, which allows to protect against accidental unscrewing but in a reversible way in that it allows unscrewing without breaking when needed.

59. The method of claim 58, using one or more blocking devices, whether said devices are blocking screws or blocking posts or a combination thereof, whose axis is parallel to the axis of the screw to be blocked in a reversible way.

60. The method of claim 59 where a clamp holds any of the blocking devices so that it engages into its appropriate blocking hole at its appropriate time.

61. The method of claim 59 where a spring helps the blocking device to get in he appropriate blocking hole at the appropriate time.

62. A method of reversible blocking of screws as recited in claim 58, using a strip or rod which gets trapped under appropriately shaped traps placed near the screw to be blocked, so that said strip prevents said screw from any motion in the direction of unscrewing once it is in place, but said strip can be taken out if unscrewing id needed.

63. A method of reversible blocking of screws as recited in claim 62, using a strip with elasticity in the direction of the axis of the screw to be blocked, and such that getting the strip in place and out is done using said elasticity of said strip.

64. The method of claim 59, where blocking devices are themselves secured.

65. The system of claim 2 where the blocking devices are themselves secured, and so on as many times as needed.

66. The method of claim 59, iterated one or more times so that blocking devices are themselves secured.

67. The system of claim 2 where the blocking devices are themselves secured using the same system, and so on as many times as needed.
